(19) United States
(12) Patent Application Publication
(10) Pub. No.: US 2001/0054005 A1
(43) Pub. Date: Dec. 20, 2001

(54) Programmable shelf tag and method for changing and updating shelf tag information

(76) Inventors: Christopher D. Hook, Holbrook, NY (US); Jeffrey W. Sutherland, Mogadore, OH (US); Timothy P. O'Hagan, Dover, NH (US)

Correspondence Address: M. David Galin, Renner, Otto, Boisselle & Sklar, LLP, 1621 Euclid Avenue, Nineteenth Floor, Cleveland, OH, 44115, US

(21) Appl. No.: 09/850,420

(22) Filed: May 7, 2001

Related U.S. Application Data
(63) Continuation-in-part of application No. 09/045,012, filed on Mar. 20, 1998, now Pat. No. 6,269,342.
Application No. 09/045,012 is a continuation-in-part of application No. 08/430,350, filed on Apr. 28, 1995, now Pat. No. 5,751,257.
(63) Continuation-in-part of application No. 09/026,826, filed on Feb. 20, 1998, now Pat. No. 6,253,190.
Application No. 09/026,826 is a continuation of application No. 08/430,350, filed on Apr. 28, 1995, now Pat. No. 5,751,257.
(63) Continuation-in-part of application No. 08/791,603, filed on Jan. 31, 1997.
Application No. 08/791,603 is a continuation-in-part of application No. 08/430,350, filed on Apr. 28, 1995, now Pat. No. 5,751,257.
Application No. 08/791,603 is a continuation-in-part of application No. 08/409,406, filed on Mar. 24, 1995, now Pat. No. 5,699,074.

(51) Int. Cl. G06F 17/60

(52) U.S. Cl. 705/20

(57) ABSTRACT

An electronic display tag system. The system has an electronic display tag including a display for displaying at least one of pricing data and product identification data, the display having bistable character elements or bistable pixels. The display tag has a decoder logic unit for decoding received programming data and for updating the display based on the programming data, the programming data being received wirelessly. The display tag also has a wireless transceiver, the wireless transceiver for converting a power inducing signal transmitted wirelessly to the display tag into electrical power, the electrical power used by the decoder logic unit to update the display.

### RELATED APPLICATIONS

The patent application is a continuation-in-part of U.S. patent application Ser. No. 09/045,012, filed Mar. 20, 1998, which is a continuation-in-part of U.S. patent application Ser. No. 08/430,350, filed Apr. 28, 1995, now U.S. Pat. No. 5,751,257; and this patent application is a continuation-in-part of co-pending U.S. patent application Ser. No. 09/026,826, filed Feb. 20, 1998, which is a continuation of U.S. patent application Ser. No. 08/430,350, filed Apr. 28, 1995, now U.S. Pat. No. 5,751,257; and this patent application is a continuation-in-part of U.S. patent application Ser. No. 08/791,603, filed Jan. 31, 1997, which is a continuation-in-part of U.S. patent application Ser. No. 08/430,350, filed Apr. 28, 1995, now U.S. Pat. No. 5,751,257, and U.S. patent application Ser. No. 08/409,406, filed Mar. 24, 1995. The content of application Ser. Nos. 09/045,012, 09/026,826 and 08/791,603 are hereby incorporated by reference in their entirety.

### TECHNICAL FIELD

This invention relates to the electronic display of information on a shelf tag, and more particularly to an electronic shelf tag that does not require additional circuitry or power to maintain the information displayed. More specifically, this invention relates to a programmable shelf tag along with an apparatus and method for programming the shelf tag.

### BACKGROUND OF THE INVENTION

Shelf tags have been used for many years to display pricing information in association with the shelving on which various products are displayed for purchase. Along with pricing information, shelf tags may include additional information including bar codes representing a product on the shelf which can be used for inventory control, as well as product information or additional material. Such shelf tags have conventionally been simply constructed of a paper material on which pricing and product information is printed, which can then be placed directly on the shelving adjacent the product to which it pertains. Shelving associated with the display of product in supermarkets and other retail stores have been designed to accommodate shelf tags, with these types of shelf tags placed within a flexible plastic casing which can be snap fit onto a shelf at an appropriate position. The plastic case allows the shelf tag to be easily removed and replaced to update pricing or other information when needed.

Although serving the desired purpose, these types of shelf tags are somewhat cumbersome in use, in that updating of the pricing information requires physical removal and replacement of the shelf tag, which for retail environments becomes time consuming and expensive. Further, updating of pricing or other information on the shelf tag requires complete replacement, necessitating continuous repurchasing of new shelf tags with properly printed updated information thereon. These characteristics of the shelf tag also result in a risk that pricing or other information is not updated accurately or the shelf tags are not replaced properly.

The above problems with common shelf tags have led to the development of electronic shelf tags. Current electronic shelf tags implement the simple function of displaying information, such as a goods price, in a complicated and expensive manner. Known electronic shelf tags require an electronic display such as a liquid crystal display (LCD), display driver circuitry, programming interface circuitry, an independent power source, and other miscellaneous control circuitry to accomplish this simple function. One major drawback to the prior art devices is that the shelf tag must continuously be supplied with power to maintain its display. Continuous power requires cumbersome and expensive wiring, as well as a power supply, or a battery local to each display. The power necessary to maintain the display has thus limited the amount of information which can be reasonably displayed and requires frequent replacement of a batter power supply. Also the addressing schemes used to write information onto typical LCD displays requires many connections making it necessary to incorporate the interface and driver circuitry directly into the shelf tag. Additionally, due to the sensitive nature of electronics to environmental conditions and LCD displays typically being made with glass, the known shelf tags are fragile and can be easily damaged by unconcerned shoppers or others unaware of the devices frail structure.

Also, to program and change the information displayed in known electronic shelf tags, a fixed connection between the shelf tag and the programming device must be maintained which is inconvenient and time consuming for persons assigned to change the information.

Further to the above deficiencies of known electronic shelf tags, a main problem is associated with their cost. With all of the necessary additional circuitry and constant power requirements, current electronic shelf tags are prohibitively expensive, particularly for large stores that would require hundreds of tags from using the electronic shelf tags in place of standard paper shelf tags.

### SUMMARY OF THE INVENTION

According to one aspect of the invention, the invention is an electronic display tag system. The system has an electronic display tag including a display for displaying at least one of pricing data and product identification data, the display having bistable character elements or bistable pixels. The display tag has a decoder logic unit for decoding received programming data and for updating the display based on the programming data, the programming data being received wirelessly. The display tag also has a wireless transceiver, the wireless transceiver for converting a power inducing signal transmitted wirelessly to the display tag into electrical power, the electrical power used by the decoder logic unit to update the display.

According to another aspect of the invention, the invention is a method of programming an electronic display tag, the display tag including a display for displaying at least one of pricing data and product identification data, the display having bistable character elements or bistable pixels, a decoder logic unit for decoding programming data and for updating the display based on the programming data. The method includes the steps of wirelessly transmitting programming data from a source to the display tag; wirelessly transmitting a power inducing signal adapted for conversion into electrical power to the display tag; converting the power inducing signal into electrical power; and updating the display based on the programming data using the electrical power.

According to yet another aspect of the invention, the invention is a programmable electronic display system which includes a display unit having a plurality of pixels in the form of an array matrix, each of the plurality of pixels having a first and second stable optical state in the absence of an electric field. The display unit has a communication port for receiving input data transmitted by a handheld and portable programming unit, said input data including display data indicating an optical state for at least one of said plurality of pixels and the display unit having a decoder for decoding said display data and modifying the optical state of the pixel array in accordance with decoded display data. Power is temporarily supplied to the display unit by the programming unit via electrical contacts disposed respectively on the display unit and the programming unit, the power used to decode the display data and modify the optical state of the pixel array.

According to still another aspect of the invention, the invention is an electronic shelf tag system. The system includes an electronic shelf tag including a display means for displaying at least one of pricing data and product identification data; a computer system for storing and communicating programming data; and a portable programming device for receiving programming data from said computer system, wherein said programming device programs the associated electronic shelf tag in accordance with the programming data received from said computer system. The portable programming device includes first communications means for wireless communications with said electronic shelf tag, second communications means for wireless communications with said computer system, and an electrical connector for temporarily supplying power to the electronic shelf tag during programming of the electronic shelf tag.

In accordance with another aspect of the invention, the invention is a method for setting an optical display device having a matrix of pixels arranged in rows and columns wherein the plurality of pixels are stable in two optical states. The method includes the steps of selectively establishing a physical electrical connection between a display device and a portable programming unit to communicate power to the display device from the programming unit and contemporaneously communicating display data to the display device from the programming unit, the display data providing a pattern for the matrix of pixels; and updating the matrix of pixels based on the display data.

In accordance with yet another aspect of the invention, the invention is a method for programming an electronic display having a plurality of pixels arranged in rows and columns to form a pixel array matrix wherein the plurality of pixels are stable in two optical states. The method includes wirelessly transmitting display data from a programming unit to a communication port, the display data indicating an optical state for each of the plurality of pixels; decoding the display data received by the communication port to obtain decoded display data; modifying the optical state of the pixel array in accordance with the decoded display data; and establishing a temporary electrical connection between the programming unit and the electronic display to provide power from the programming unit to the electronic display for decoding the display data and modifying the optical state of the pixel array.

### BRIEF DESCRIPTION OF DRAWINGS

FIG. 1 is a perspective view of the shelf tag according to a first embodiment showing price display digits and bar code display digits;

FIGS. 2A and 2B show plan views of front and back plates of the shelf tag shown in FIG. 1;

FIG. 3 is an exploded perspective view of the shelf tag shown in FIG. 1;

FIG. 4 is a side elevational exploded view of an alternative embodiment of the shelf tag shown in FIG. 1;

FIG. 5 is magnified side elevational view of an optical bar code reader wand with a shelf tag programming interface;

FIG. 6A represents schematically a plurality of exemplary voltage wave forms used to switch the optical state of each character element of the bistable liquid crystal display shown in FIG. 1;

FIG. 6B is a flow chart indicating a typical sequence for programming the shelf tag shown in FIG. 1;

FIG. 7 is a perspective view of a stand-alone shelf tag programming device;

FIG. 8 is a block diagram of the circuitry of the stand-alone shelf tag programming device shown in FIG. 7;

FIG. 9 is a system diagram of components to implement a method of taking inventory and updating price and other information via radio frequency computer local area network. The system diagram includes a representation of a radio frequency computer local area network, a shelf tag and a portable tele-transaction computer equipped with an optical bar code reader wand and a shelf tag programming interface;

FIG. 10 is a cross-sectional side view through an exemplary bistable liquid crystal display unit in accordance with a second embodiment of the present invention;

FIG. 11 is a schematic of a display unit and a block diagram of a control unit, in accordance with a second embodiment of the present invention[

FIG. 12 shows a plurality of exemplary voltage waveforms generating by the display driver shown in FIG. 2, to selectively switch the optical state of each desired pixel of the liquid crystal display unit shown in FIG. 1;

FIG. 13 is a block diagram of an exemplary decoder logic unit in accordance with a second embodiment of the present invention;

FIG. 14 is a diagrammatic representation of a serial input data signal including a row of pixel data for programming the programmable electronic display system of the present invention;

FIG. 14 is a state diagram of the decoder logic unit shown in FIG. 4;

FIG. 16 is a perspective view of a shelf tag having row and column conductor electrodes, together with associated control circuitry and communications port for programming same;

FIGS. 17A and 17B illustrate surfaces of a shelf tag in accordance with a second embodiment of the present invention;

FIG. 18 is a cross-sectional view of a shelf tag in accordance with a second embodiment of the present invention;

FIG. 19 is a perspective view of a communications port according to a second embodiment of the present invention;

FIG. 20 is a block diagram of an exemplary programming unit for the pixel array of the bistable liquid crystal display unit shown in FIG. 1;

FIG. 21 is an illustration of a network including a local area network, a programming unit, and a shelf tag according to a second embodiment of the present invention;

FIG. 22 is a view of a wand for a programming unit;

FIG. 23 is a perspective view of an alternate embodiment of the programming unit;

FIG. 24 is a system diagram of components for a third embodiment of a shelf tag;

FIG. 25 is a block diagram of an example decoder circuit for the shelf tag according to the third embodiment;

FIG. 26 is a block diagram of a network using wireless mediums to communicate with a shelf tag; and

FIG. 27 illustrates of a physical implementation of the network shown in FIG. 26.

### DETAILED DESCRIPTION

In the detailed description which follows, identical components have been given the same reference numerals, regardless of whether they are shown in different embodiments of the present invention. To illustrate the present invention in a clear and concise manner, the drawings may not necessarily be to scale and ceratin features may be shown in somewhat schematic form.

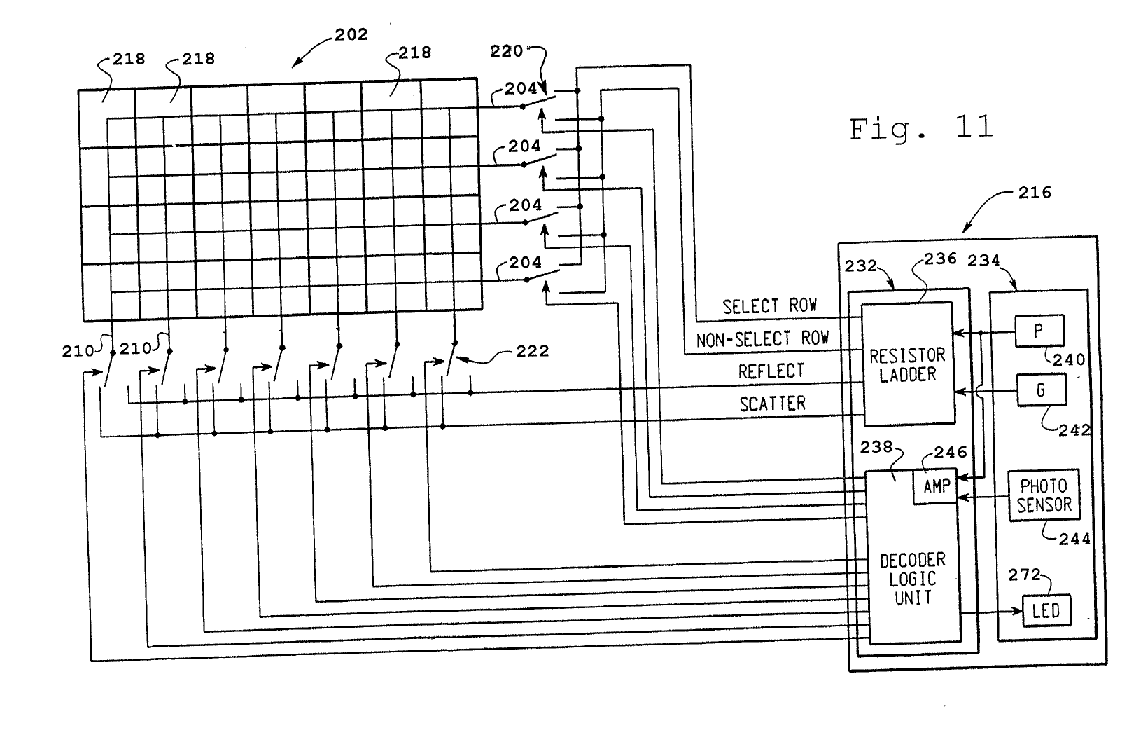

Referring now to the drawings, a first embodiment of a shelf tag 10 according to the invention is shown in FIG. 12. The shelf tag includes a liquid crystal display (LCD) comprised of a layer of liquid crystals, schematically shown at 26 sandwiched between a transparent surface 16 and a light absorbing (i.e., black) surface 18. The liquid crystal layer 26 is formed of liquid crystal material having first and second optical states which are both stable in the absence of an electric field. Formed in the liquid crystals display are individual character elements 12 used to generate numerals, alpha-numeric characters for lettering, bar codes and/or other characters or forms to be displayed. To program the character elements 12 between the first and second optical states, an interface to the character elements 12 includes a common contact 24 and a set of signal contracts 20. A programmer alignment track 22 may be used to guide a programming device linearly across the common contact 24 and the signal contacts 20. Printed or otherwise formed along the front of the transparent surface 16 are synchronizing indicators 14 which provide feedback to a programming device as to which character element 12 is to be programmed.

It should be recognized from the foregoing, that the shelf tag 10 provides a very simple structure which can be fabricated using flexible plastic substrates such as Mylar film or other suitable flexible plastic materials. These materials are easily produced in the desired configuration and are extremely cost effective, to make a shelf tag 10 viable for large scale use in retail environments. Forming the shelf tag 10 of flexible plastic substrates also makes the shelf tag 10 compatible with common display shelving, wherein the shelf tag 10 can be bent slightly so as to snap into existing retaining devices already attached to such shelving. In this way, the shelf tag 10 will not require any external packaging, again enhancing its cost effective manufacture and use.

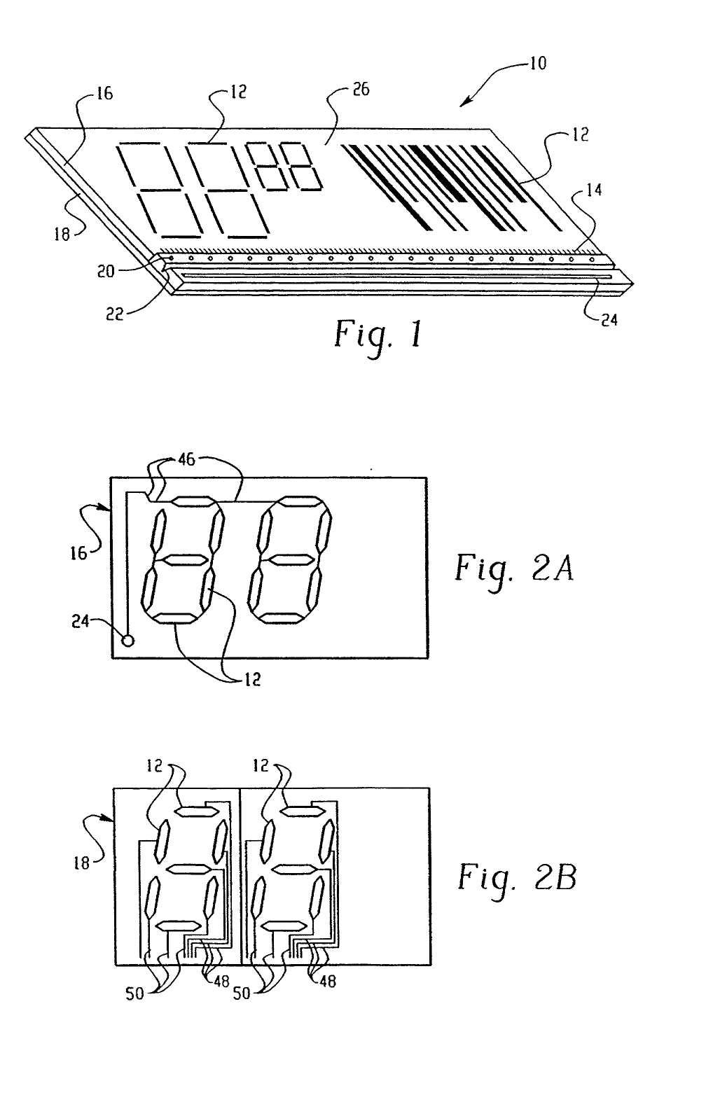

Turning to FIGS. 2A and 2B, the surfaces 16 and 18 forming a part of the shelf tag 10 shown in FIG. 1 are shown in an embodiment thereof. In FIG. 2A, the front or top surface 16 of the shelf tag 10 is a transparent sheet of a plastic material having front and back surfaces, with the back surface having character elements as well as conductors formed thereon. As an example, the Mylar film or other suitable sheet of plastic material may be coated with a layer of indium tin oxide, which can then be etched to provide the individual desired character or display elements 12 as well as to provide various conductor elements 46 and common conductor 24. In this particular embodiment, the character elements 12 are all connected to one another via a common conductor coupled to a contact 24 and comprising the individual conductor elements 46. As shown in FIG. 2A, the character elements 12 may be positioned to form a common digital eight configuration including seven individual character elements, so as to enable display of pricing information. Alternatively, character elements 12 may be otherwise configured to display other desired information, such as alpha-numeric characters utilizing similar eleven character elements 12 in a known manner. Because the character elements 12 are easily formed by etching or similar process, any other display configurations for character elements 12 may be used in association with the shelf tag 10. Referring back to FIG. 1, other display elements 12 can thus be used to make up a bar code configuration which can be formed in a similar manner.

In conjunction with a top surface 16 as shown in FIG. 2A, the bottom surface 18 is configured in a corresponding fashion, to match character elements 12 formed on the top sheet 16. As previously indicated with respect to FIG. 1, between top sheet 16 and bottom sheet 18, a layer of liquid crystal material 26 is formed, with character elements 12 formed on the bottom of the sheet 16 and top of the sheet 18 in matching relationship such that liquid crystal material 26 is disposed between each pair of character elements 12. The character elements 12 formed on the bottom sheet 18 may also be etched from a coating of conductive material such as indium tin oxide to provide the individual desired elements 12, along with conductors 48 formed for each of the character elements 12 on the bottom sheet 18. The conductors 48 are fed to a bottom side of the sheet 18, and in turn form a set of individual contacts 50 used to interface with each of the individual character elements 12 formed on the top surface of the sheet 18. In both FIGS. 2A and 2B, the character elements 12 as well as conductors 46 and 48 provide transparent electrodes applied to respective adjacent sides of the plates 16 and 18, with corresponding electrodes forming character elements 12 on the plates 16 and 18 used to impress an electric field across the liquid crystal material 26 disposed there between. The electric field is used to switch the optical states of the liquid crystal material 26.

The shelf tag 10 is constructed around the use of liquid crystal material 26 which have two optical states, both stable in the absence of any electric field. By injecting a polymeric stabilizer into the liquid crystals 26, two unenergized stable optical states are produced. The two optic states consist of a scattering or focal conic state, where light passes through the liquid crystal 26 to appear transparent, and a reflecting or planar state where light does not pass through the liquid crystal 26. The liquid crystal material 26 is therefore sandwiched between the transparent character elements 12 on plate 16 which are coupled to common conductor 46 and character elements 12 on the back plate 18 coupled to individual conductors 48 for each character element 12. The back plate 18 could be formed a transparent reflective or opaque (i.e., black) or have its back surface provided with an opaque layer or coating. In operation when the optical condition of the liquid crystal 16 character elements 12 allows light to pass, the viewer sees the black surface formed on sheet 18, making the character element 12 appear dark. When the optical condition of the liquid crystal 26 does not allow light to pass, light entering from the transparent front plate 16 is reflected making the character element 12 appear light and virtually unreadable.

In an embodiment of the shelf tag 10, the LCD display uses stabilized cholesteric liquid materials which exhibit bistable behavior. This liquid crystal material and application in an LCD is described in more detail in Cholesteric Liquid Crystal/Polymer GEL DISPERSION:Reflective Display Application (May 1992) SID Digest of Technical Papers, pp. 759-782, Cholesteric Reflective Display: Drive Scheme & Contract (1992), Journal of Applied Physics, Vol. 65, no. 15, page 1905, and Control of Reflectivity & Bistability in Displays using Cholesteric Liquid Crystals (1994), Journal of Applied Physics, Vol. 76, No. 2, page 1331, each of which are expressly incorporated herein by reference in their entireties. In construction, the flexible substrate, being either front plate 16 or back plate 18 may be laminated with a layer of polymer stabilized cholesteric liquid crystal material 26. Subsequently, when plates 16 and 18 are then positioned adjacent one another to sandwich the liquid crystal material 26 there between. Control signals may be applied to the common contact 24 and individual ones of the signal contacts 20 to change the optical state of the bistable liquid crystal material 26 between either reflecting or scattering optical states to generate a desired display on the LCD. Control signals may be symmetrical wave forms providing an instantaneous voltage magnitude across a particular character element defined by the etched transparent conductors forming the character elements on the top and back plates 16 and 18 respectively, so as to change the optical state of the liquid crystal material 26 for that character element 12. The individual signal contacts 20 and associated conductors 46 in conjunction with the common contact 24 and corresponding conductor 48 allow any of the individual character elements 12 to be changed from the reflecting or scattering optical states accordingly.

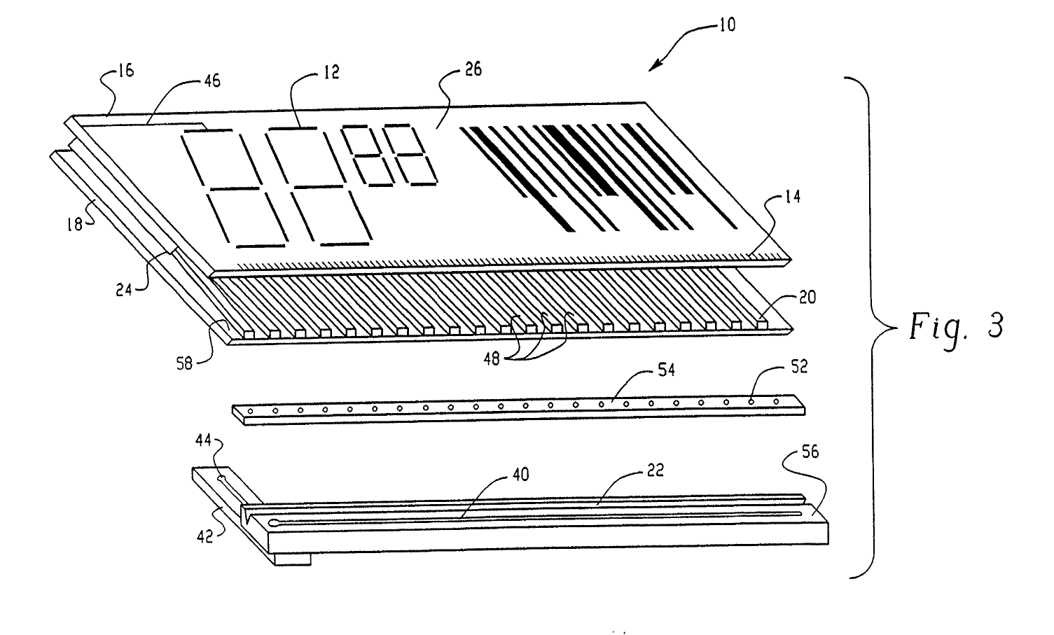

In order to easily interface a programming device to the shelf tag 10, the set of signal contacts 20, and common contact 24 are used. In an embodiment as shown in FIG. 3, the common contact 24 may be interfaced by means of a nonconductive strip 56, preferably plastic, which can easily be configured with an alignment track 22 molded or cut in the shape of a groove running the length of the strip 56. Below the alignment track 22 is an electrical conductor 40 embedded into the strip 56 and exposed on the top of the strip 56 to provide an interface for coupling reference signals to the common contract 24. At one end of the strip 54, the electrical conductor 46 is disposed through the strip 56 to allow a connection of a conductor 40 from the bottom side of the strip 56. On one end of the strip 56, an extension arm 42 extends outward, with extension arm 42 having an electrical conductor 44 embedded in it which is exposed on one side of the extension arm 42. The electrical conductor 44 is coupled to the electrical conductor 40 in the strip 56, and in turn is electrically coupled to the common contact 24 upon being assembled in shelf tag 10. To interface to the individual signal contacts 20 and to conductors 48 of each character element 12, a set of individual conductors 52 may be formed in an elongated nonconductive strip 54 so that the individual conductors 52 pass through both sides of the strip 54. Conductors 52 are coupled to individual signal contacts 20 upon assembly of the strip 54 with the tag 10 as will be described hereinafter.

As seen in FIG. 3, the back plate 18 is wider than the front plate 16 to expose contacts 20 beyond the front plate 16. Similarly, the length of the front plate 16 allows the common contact 24 to be exposed beyond the back plate 18 when the plates are positioned adjacent one another. When connecting the components that make up the shelf tag 10, the back plate 18 provides a base which all other components will be stacked on and attached to by methods common in the art such as adhesives. The strip 56 with the extension arm 42 attached is placed on the back plate 18 along its lower front edge 58, such that the conductor 44 connects to the common contact 24 in turn connecting the contact 24 to the strip conductor 40. The strip 54 with the conductors 52 is positioned adjacent the strip 56 with each of the conductors 52 connecting to an individual contact 20. The transparent front plate 16 is placed on top of the back plate 18. Each individual conductor 52 is aligned with and electrically coupled to each corresponding contact 20 completing the interface path from the individual conductors 52 to the individual contacts 20 and to each conductor of each character element 12. In this manner, each of the individual contacts 20 is electrically accessible by means of conductors 52 at a position exterior to the shelf tag 10 while providing a compact shelf tag construction. Similarly, the common contact 24 is electrically coupled to the strip conductor 40 which is easily accessible adjacent each of the individual conductors 52, such that each of the common and individual contacts 24 and 20 respectively can be fed data signals generated by a programming device at an easily accessible position on the shelf tag 10.

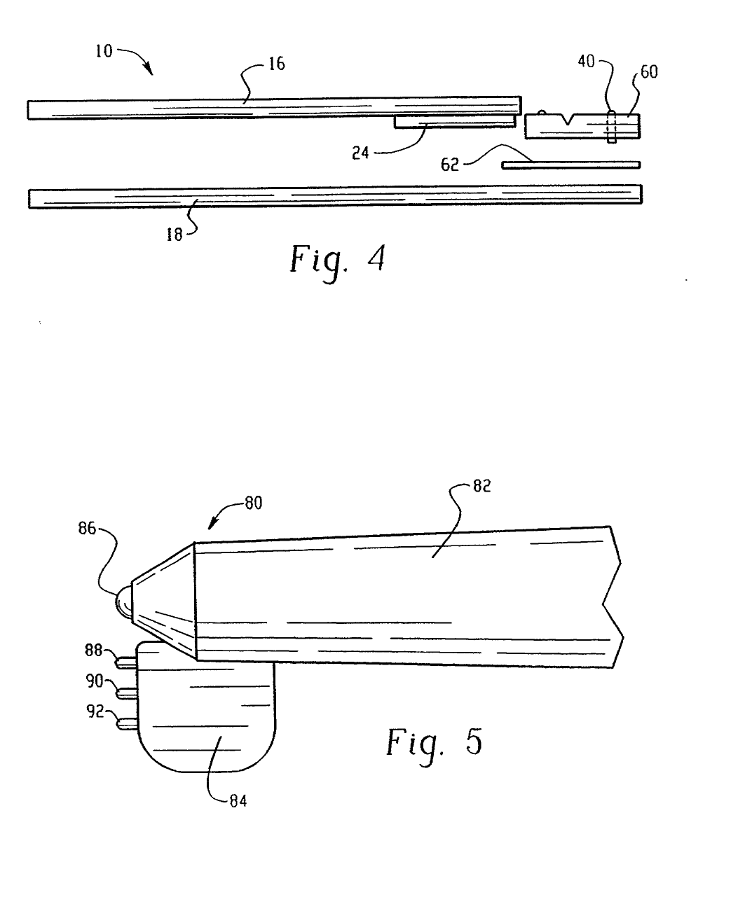

In an alternative embodiment of the shelf tag 10, as shown in FIG. 4, a combined contact strip and guide 60 is used to replace the combination of a nonconductive strip 56 and extension arm 42 as shown in FIG. 3. A conductive adhesive 62, such as a z-axis conductive adhesive, may be placed on the back plate 18 along its lower front edge or at a similar relative location, such that upon joining of the front plate 16 and back plate 18, the conductive adhesive 62 electrically couples common contacts 24 with the strip conductor 40. The arrangement of individual conductors 52 may be configured in a manner similar to that shown in FIG. 3 to be electrically coupled to the contacts 20. This combination allows for simpler production of the shelf tag and fewer components which both add cost savings to the shelf tag. Other suitable arrangements for electrically coupling the common and individual contacts of the shelf tag to be accessible exterior to the shelf tag 10 are also contemplated in the invention.

The set of synchronizing indicators 14 are printed or otherwise formed into the front plate 16 along its lower edge running length wise. In the illustrated embodiment, these synchronizing indicators 14 will be read optically to provide a programming device with feedback as to which character element 12 it is coupled with, to correctly program the individual character elements 12 for display of desired information via the LCD. In the illustrated embodiment, the synchronizing indicators 14 may assume a similar configuration to that of a bar code using a plurality of dark and light areas. A typical bar code reader and decoder arrangement is described in U.S. Pat. No. 4,104,514, which is hereby incorporated by reference herein as a suitable arrangement for configuring the synchronizing indicators 14 in a bar code format to be read and decoded in a similar manner. Conventionally, the dark areas are referred to as bars, while the light areas are referred to as spaces. Information typically is carried in the width of the bars as well as the width of the spaces along with their relationship to one another. Generally, an optical signal is generated by admitting light onto the series of bars and spaces, and receiving via an optical detector reflected light from the surface. An analog wave form representing the bar/pattern is generated by the optical detector and is digitized, wherein a bar may be represented by a “One” value and a space represented by a “Zero”. The synchronizing indicators 14 may then be similarly read by relative movement of the indicators 14 relative to the optical reader. The sequence of bars and spaces, referred to as elements, are then read with the width of each element being a multiple of a standard dimension called a module. In most bar codes, elements are from 1-3 modules wide, with the character set representable by the bar code and the number of elements per character are varying form one symbology to another. Any bar code configuration may therefore be useable in the present invention, with conventional bar code readers also usable in conjunction with the invention. The synchronizing indicators 14 may include a preamble section which will indicate the beginning and set the format for scanning and reading the synchronizing indicators 14. The illustrated embodiment uses optics to synchronize the programming device but other devices such as mechanical or electrical contacts could be used to provide pulse or count information indicative of the position of contacts associated with each character element 12.

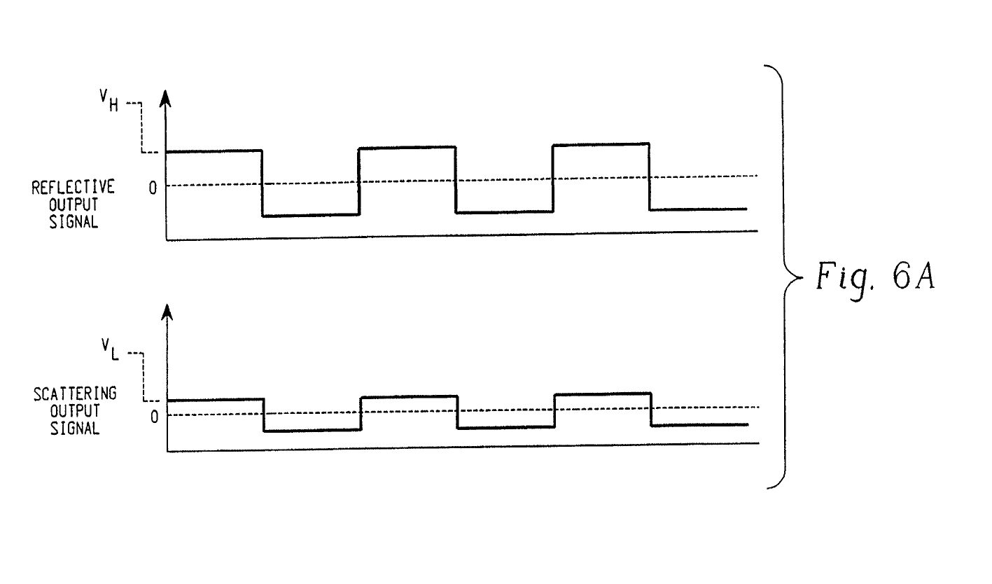

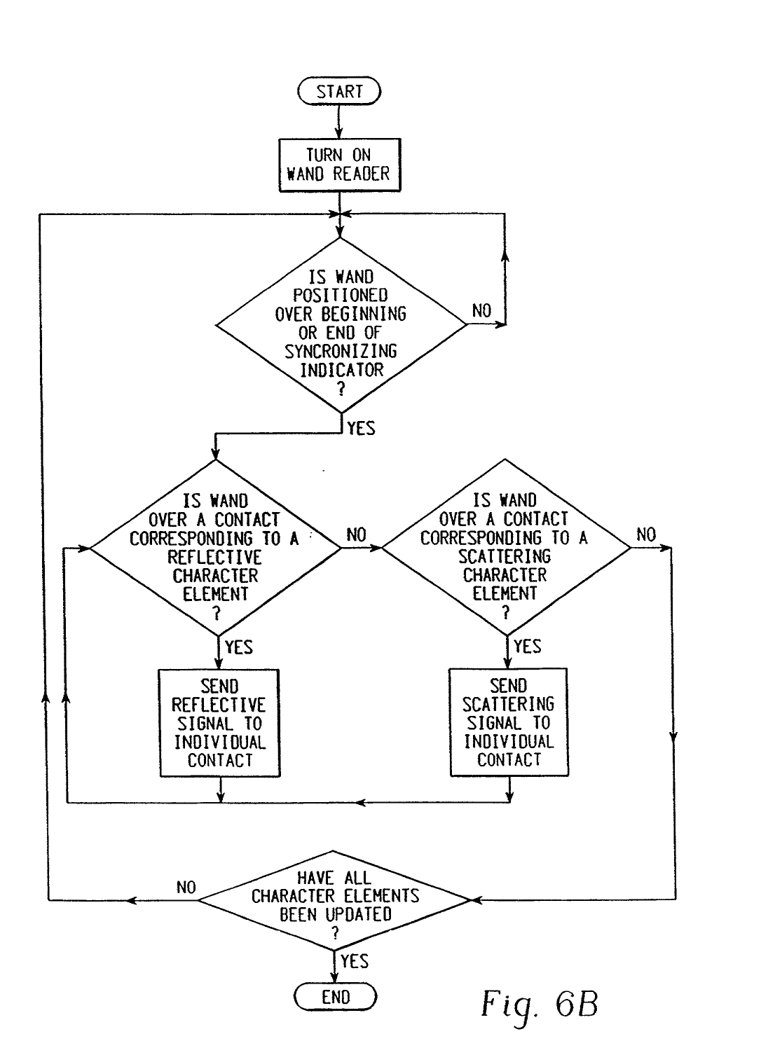

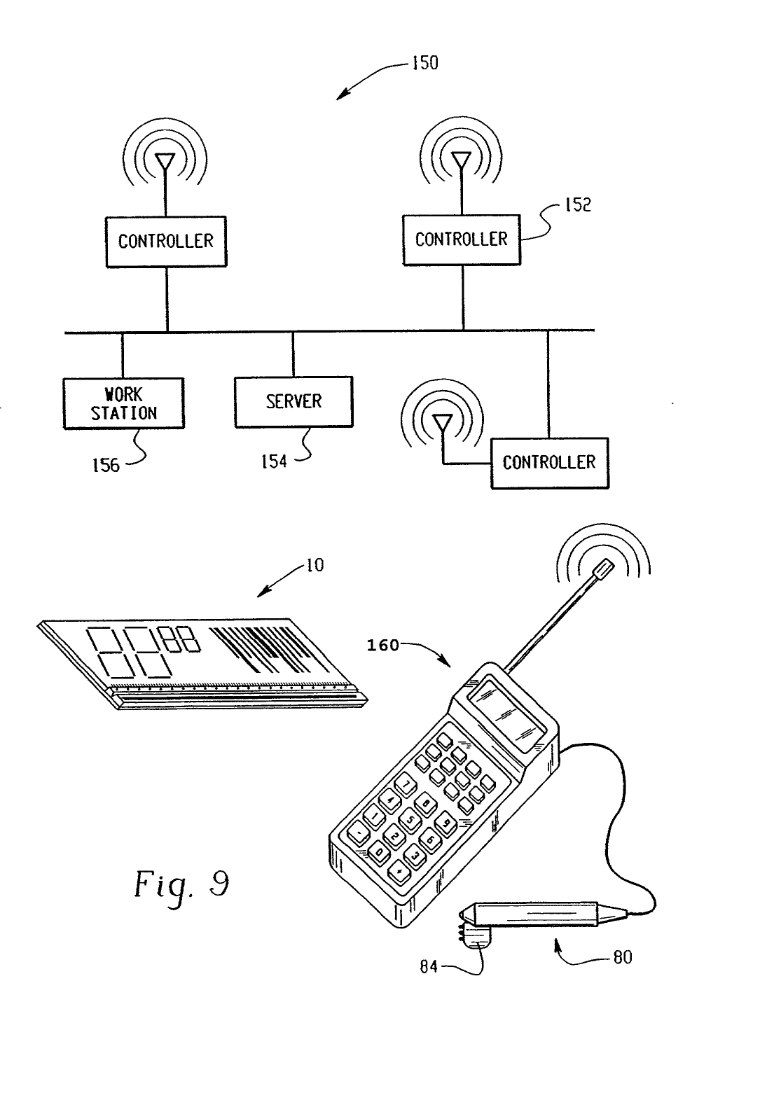

A first embodiment of a programming device 160 used to change the shelf tag's 10 display is shown in FIG. 9. The programming device 160 is a portable tele-transaction computer capable of sending and receiving information via radio frequency carrier signals, accepting user input via keypad and reading bar code information and outputting shelf tag 10 programming data. Referring to FIG. 5, to perform the programming of the shelf tag 10, an optical bar code reader wand 80 with a programming interface 84 for use with shelf tag 10 may be used. The illustrated embodiment of the wand 80 has a pen-shaped elongated body 82 typically fabricated from plastic or metal with an optical sensor 86 provided in the top of the body 82. Below the optical sensor 86 the programming interface 84 is mounted to the body 82. Extending from and securely mounted to the programming interface 84 is the individual output pin 88, the alignment pin 90 and the common output pin 92. Also in the illustrated embodiment, the use of alignment track 22 on tag 10 allows proper positioning of output pins 88 and 92 in conjunction with an alignment pin 90. The alignment pin 90 is only used for mechanical alignment of the interface 84 with tag 10. The alignment pin 90 is placed by the user in the programmer alignment track 22 of the shelf tag 10. By keeping the alignment pin 90 in the track 22 the user can sweep across the common contract 24 and the set of signal contacts 20 in an even and linear manner. It should be noted that the alignment pin 90 and track 22 are for the users benefit but neither is necessary to the programming of the shelf tag 10. All that is needed is a proper connection of the output pins 88 and 92 and the signal contacts 20 and the common contact 24 respectively. FIG. 6A shows an example of the relationship between the signals emitted through the common output pin 92 and the individual output pins 88 used to change the optical state of character elements 12. The common output pin 92 provides a ground reference to the common contact 24. To maintain a reflective optical state on the character element 12, the individual output pin 88 also emits a wave form symmetrical about zero with a peak to peak magnitude of V_{H} as shown in FIG. 6A. To change the character element 12 from the reflective optical state to a scattering state, the same common signal should be output from the common output pin 92 and the individual output pin 88 should follow the wave form shown in FIG. 6A for a scattering optical state which is a symmetrical wave form of V_{L} wherein V_{L} is the voltage necessary to change to scattering. It should be noted that both the reflective and scattering wave forms differ in magnitude. The optical sensor 86, the individual output pin 88 and the common output pin 92 are all electrically coupled to the programming device 160 by wires running through the body 82 of the wand 80 and back to the programming device 160. A typical sequence of steps for programming a shelf tag 10 are shown in the flow chart of FIG. 6B. The sequence may begin by turning the optical sensor 86 of the wand 80 on. The programming device 160 will then determine whether the wand is positioned over the beginning or the end of the synchronizing indicators 14. If not, the program will loop back and continue to check whether the wand is positioned over the beginning or end of the synchronizing indicators 14. Once the wand 80 is positioned correctly the programming device 160 will determine if the wand 80 is over a signal contact 20 corresponding to a character element 12 that is to be programmed to a reflective optical state. If it is, the programming device 160 will send a reflective signal to pin 88 to cause the character element 12 to take on a reflective state. Alternatively, if the wand is over a contact for a character element to be updated to a scattering state, this is determined in a next processing step, and a corresponding scattering signal is sent to the individual output pin 88. The programming device will loop back and repeat the above sequence until it is determined if all character elements 12 have been updated. If so, the program will end and if not, the program will loop back and determine if the wand 80 is positioned over the beginning or end of the synchronizing indicators 14.

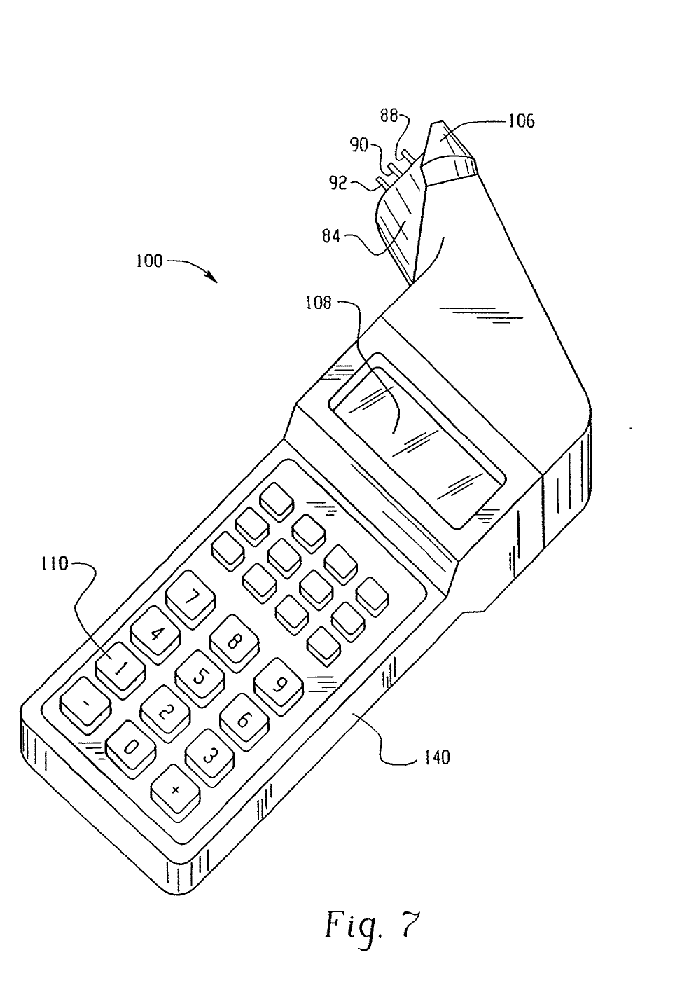

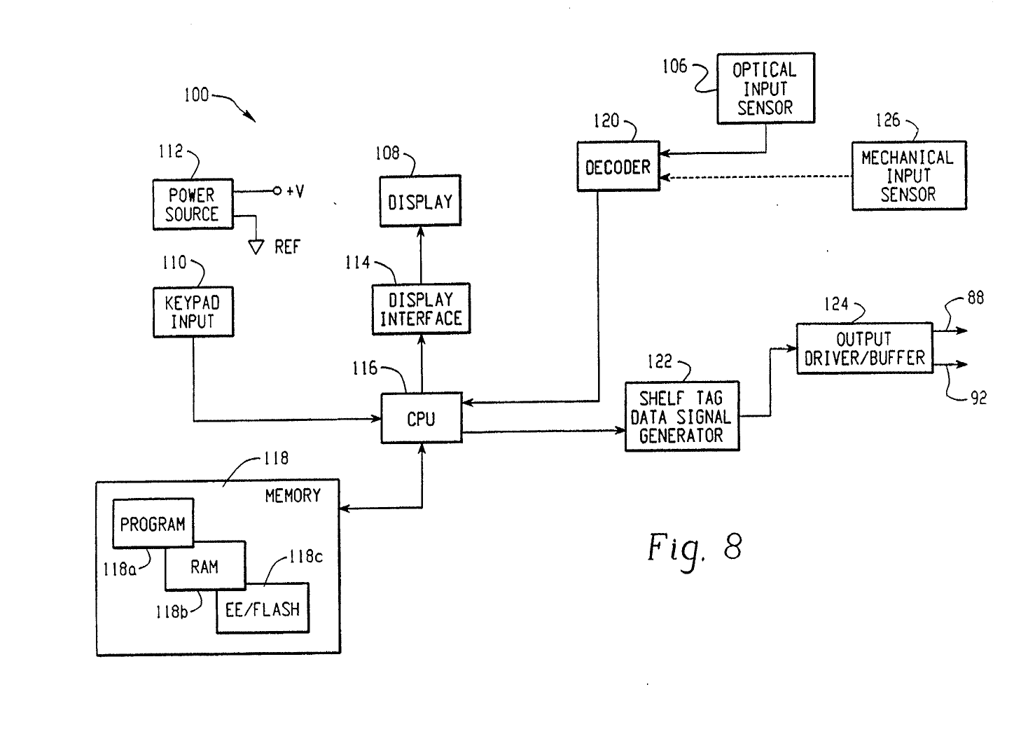

Although the illustrated embodiment of the programming device 160 is the portable tele-transaction computer, such as that depicted in FIG. 9, an alternate embodiment is shown in FIGS. 7 and 8. A hand-held stand-alone programmer 100 is shown in FIG. 7 which incorporates a small, easily handled housing 140 manufactured from durable hardened plastic or rubber. The programmer may include a keypad 110 for user input to be programmed into the shelf tags 10, or another input mechanism may be provided. Optionally the programmer 100 may include an electronic display 108 to prompt and view user input. A fixed optical sensor 106 for synchronizing programmer 100 with tag 10 may again be provided, or suitable alternative arrangements. The programming interface 84 as shown in FIG. 5 again may comprise an alignment pin 90, an individual output pin 88 and a common output pin 92. FIG. 8 depicts the stand-alone programmer 100 in functional block diagram format. A central processing unit or CPU 116 performs all of the data input and output control and manipulation. The CPU 116 reads the program memory 118A for operation. The CPU 116 uses the random access memory or RAM 118B for manipulating data and as an option it may use nonvolatile memory 118C (EEPROM, FLASH, NOVRAM) to maintain user setpoints or database information which needs to be retained when power is not applied. The CPU 116 receives user input from the keypad 110 or other input device, and displays information for the user by sending data to the display interface 114 which then controls how the display 108 outputs the data. The optical sensor 106 transforms light into data which is then sent to a decoder 120 which prepares the data into the proper digital format for use by the CPU 116. An alternate option for use with a mechanical synchronization mechanism is a mechanical input sensor 126 which would translate mechanical movement into data for use by the CPU 116. Data to be programmed into the shelf tag 10 is sent from the CPU 126 to the shelf tag data signal generator 122 which converts the digital information into the proper format needed for changing the character elements 12 on the shelf tag 10. The formatted data is then transmitted to an output driver/buffer 124 in order to output data through the individual output pin 88 and the common output pin 92. Power is supplied to all circuitry by power source 112 which will typically be a battery, preferably rechargeable. Power could be supplied by other sources such as AC/DC adapters, solar power cells or other sources of electrical power. It should be understood that the above description of the circuitry is only illustrative, many functions can be accomplished in different electronic means, for example, many display devices have display interface circuitry incorporated into them and many CPUs have different types of memory integrated into a single chip. The functions represented can therefore be electronically implemented in many different ways by someone of ordinary skill in the art.

In the course of normal operation, the stand-alone programmer 100 and the programming device 160 will be coupled by the user to the shelf tag 10 by placing the programming interface 84 adjacent shelf tag 10, and particularly with alignment pin 90 in the programmer alignment track 22 of the shelf tag 10. The programming interface 84 is swept across tag 10, either in the form of the wand 80 or the stand-alone programmer 100, from one side of the shelf tag 10 to the other in a linear fashion. The individual output pin 88 will be electrically coupled to each individual conductor 52 of the set of signal contacts 20 in turn during this sweeping action, and the common output pin 92 will be electrically coupled to the electrical conductor 40 of the common contact 24 at all times. As the programming interface 84 is moved from across the shelf tag 10 either the optical sensor 86, the optical input sensor 106 or the mechanical input sensor 126, will read the synchronizing indicators 14 on the front of the shelf tag 10 and supply the stand-alone programmer 100 or the programming device 160 with data relating to which character element 12 the programming interface 84 is currently coupled to for proper programming. Next the proper data signals are output to the shelf tag 10 and the desired character elements 12 are changed. As previously indicated, the synchronizing indicators 14 may include information stored in a preamble section of the synchronizing pattern to be used to differentiate among different shelf tag formats which are possible. The invention is therefore not limited to any particular configuration or format, with the shelf tags 10 themselves potentially of a variety of configurations to display any variety of information with the display on the tag not fixed to any single format. The information stored in the preamble section of the synchronizing patter 14 may therefore be used to differentiate among various shelf tag formats, with the programming interface 84 adapting to any such configuration.

Referring to FIG. 9, as a possible application of the invention, a plurality of shelf tags 10 will be placed on shelves near products and the shelf tag 10 will display the products price and a corresponding UPC bar code. The shelf tags 20 will be used in conjunction with a programming device 160 such as a portable tele-transaction computer (PTC) equipped with an optical bar code reader wand 80 having a shelf tag 10 programming interface 84. The PTC will be equipped with radio frequency communication capabilities that will allow it to communicate throughout the application site (i.e., a store or supermarket) with a radio frequency computer local area network (LAN) 150. The LAN 150 would be connected to at least one computer server 154, at least one computer work station 156 and at least one computer controller 152. As a store clerk is using the PTC to take inventory through the use of scanning bar codes on products or by scanning bar codes on the shelf tags 10, the PTC would communicate packets of data to the controller 152 via radio frequency. The controller 152 would then transfer the inventory data to the server 154 and/or work station 156 where the data would be processed. If the computer determines that a price needs to be changed for a particular product, the work station 156 or server 1564 would direct the controller 152 to send packets of information to the PTC or programming device 160 via radio frequency. The information sent to the programming device 160 would contain a message that a particular products price needed to be changed and update information relating thereto. Once the programming device 160 receives the packets of information it would signal the user, either visually with an indicator light or message prompt, or through an audio tone or both. The user would then know to use the programming interface 84 to change the information displayed by the shelf tag 10. This type of system application would save a great deal of time and paper work while providing for greater accuracy by taking the task of properly updating shelf tag information out of the hands of store clerks who are human and are prone to make mistakes.

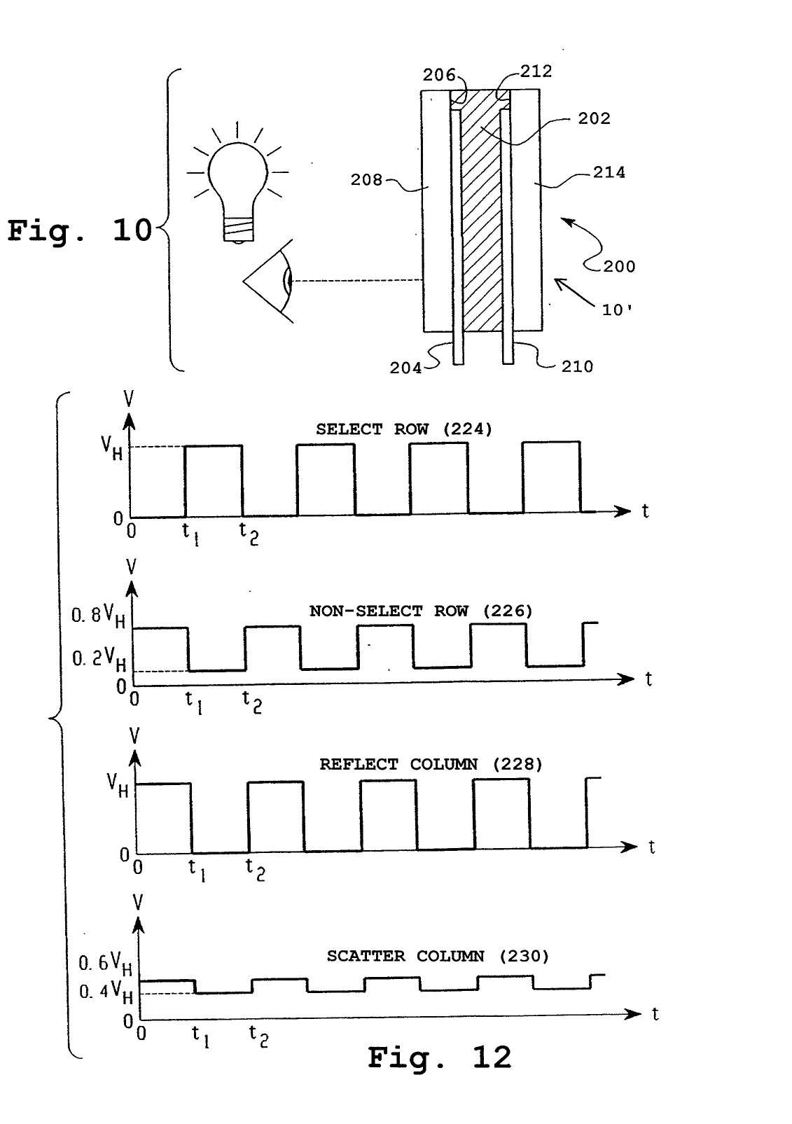

Referring now to FIGS. 10 through 23, a second embodiment of a shelf tag 10′ will be described. FIG. 10 shows a cross-sectional side view through an exemplary scattering type LCD display unit 200, suitable for use in conjunction with the shelf tag 10′. The LCD display unit 200 is comprised of liquid crystals 202 having two optical states, both stable in the absence of any electric field. By injecting a polymeric stabilizer into liquid crystals 202, two unenergized stable optical state are produced. The polymeric stabilizer will be described in detail below. The two optical states consist of a scattering or focal conic state, where light passes through liquid crystals 202 to appear transparent, and a reflecting or planar state, where light does not pass through liquid crystals 202.

The liquid crystals 202 are sandwiched between a transparent row of conductor electrodes 204 on the back surface 206 of a front transparent film 208, and a transparent column conductor electrodes 210 on the front surface 212 of a light absorbing film 214. Light absorbing film 214 may be formed from a transparent material and have its back surface provided with an opaque (i.e., black) layer or coating or, alternatively, light absorbing film 214 itself may be formed from an opaque material. Row conductor electrodes 204 and column conductor electrodes 210 define pixel elements formed of liquid crystals 202, as will be described in detail below. Individual pixel elements are used to form alphanumeric characters or other graphics. In an operation where the optical condition of liquid crystals 202 allows light to pass therethrough (i.e., transparent state), a viewer will see the opaque surface of light absorbing film 214 making the pixel elements appear dark. When the optical condition of liquid crystals 202 does not allow light to pass (i.e., reflective state), light entering from transparent film 208 is reflected, making the pixel elements appear light.

In an embodiment of the present invention, the polymeric stabilizer used in LCD display unit 200 is a stabilized cholesteric liquid material which exhibits bistable behavior. This liquid crystal material and application in an LCD display is described in more detail in Cholesteric Liquid Crystal/Polymer GEL DISPERSION:Reflective Display Application (May 1992), SID Digest of Technical Papers, pp. 759-782; Cholesteric Reflective Display:Drive Scheme & Contrast (1992), Journal of Applied Physics, Vol. 64, No. 15, page 1905; and Control of Reflectivity & Bistability in Displays using Cholesteric Liquid Crystals (1994), Journal of Applied Physics, Vol. 76, No. 2, page 1331, each of which are expressly incorporated herein by reference in their entireties.

In constructing LCD display unit 200, transparent film 208 or light absorbing film 214 may be laminated with a layer of liquid crystals 202 comprised of a polymer stabilized cholesteric liquid crystal material. Subsequently, transparent film 208 and light absorbing film 214 are positioned adjacent one another to sandwich the liquid crystals 202 therebetween. Control signals may then be applied to row conductor electrodes 204 and column conductor electrodes 210 to change the optical state of the liquid crystals 202 between the scattering and reflecting optical states. As a result, a desired display image is generated on LCD display unit 200. The control signals may be symmetrical waveforms providing an instantaneous voltage magnitude across a particular pixel element defined by electrodes 204, 210 so as to change the optical state of the liquid crystals 202 corresponding to that pixel element. It should be appreciated that multiplexed signals, as described in U.S. patent application Ser. No. 08/409,406 are applied to each one of the row conductor electrodes 204 and to each one of the column conductor electrodes 210 to provide for the ability to change the state of any individual pixel element.

FIG. 11 shows an exemplary schematic of LCD display unit 200 and an exemplary block diagram of a control unit 216 for controlling LCD display unit 202. Display unit 202 is comprised of a matrix of individual pixel elements 218. Each pixel element 218 is comprised of the structure described in connection with FIG. 10. For the purpose of illustration only, FIG. 11 shows a matrix of seven columns and four rows of pixel elements 218. Each pixel element 218 within the matrix is defined by the intersection between one of the row conductor electrodes 204 and one of the transparent column conductors 210. When a voltage signal is applied to one of the row conductor electrodes 204 and a complimentary voltage signal is applied to one of the column conductor electrodes 210 a differential voltage is applied across liquid crystals 202 of a pixel element 218 to control their optical state.

In an exemplary embodiment of the present invention, row switches 220 are associated with row conductor electrodes 204 to selectively couple each row conductor electrode to a “select row” voltage signal or to a “non-select row” voltage signal. Column switches 222 are associated with column conductor electrodes 210 to selectively couple each column conductor electrode to a “reflect” voltage signal or to a “scatter” voltage signal. Each of these voltage signals enables optical control of each individual pixel element 218, as will be discussed below. When a “select row” signal is applied to a row conductor electrode and a “reflect” signal is applied to a column conductor electrode, the differential voltage therebetween is effective to change (or maintain) the optical state of liquid crystals 202 of a pixel element 218, a the intersection between the row conductor electrode and column conductor electrode in a “reflect” optical state. Likewise, when a “select row” signal is applied to a row conductor electrode and a “scatter” signal is applied to a column conductor electrode, the differential voltage between the “select row” signal and the “scatter” signal is effective to change (or maintain) the optical state of liquid crystals 202 of a pixel element 218, at the intersection between the row conductor electrode and the column conductor electrode in a “scatter” optical state.

It should be understood that the differential voltage between the “non-select” row signal and either of the “reflect” signal or the “scatter” signal is not effective to change the optical state of the liquid crystals 202 forming pixel elements 218. Therefore, it should be appreciated that the displayed contents of LCD display 202 may be changed by applying a “select row” signal to only one row at a time, while applying a “non-select” row signal to each of the remaining rows. An appropriate “reflect” or “scatter” signal is applied to each column conductor electrode to set the optical state of liquid crystals 202 of pixel elements 218 in the selected row to the desired optical state. This process is then repeated for each row until the entire LCD display unit 200 has been updated.

FIG. 12 shows waveforms of a “select row” signal 224, a “non-select row” 226, a “reflect” column signal 228 and a “scatter” column signal 230. These four signals have maximum voltages and minimum voltages that are all of the same polarity and vary between V_{H} and zero volts, where V_{H} is a predetermined voltage magnitude adequate to change a pixel element 218 from a scattering optical state to a reflecting optical state, 0.6 V_{H} does not alter the existing optical state of any pixel element 218 across which such a voltage magnitude is applied. It should be appreciated that the waveforms shown in FIG. 12 are not necessarily to scale or in time relation to each other.

It should be noted that select row signal 224 is 180° out-of-phase with the other three signals 226, 228 and 230, each of which is in phase (or in-sequence) with each other. In other words, whenever “select row” signal 224 is at its voltage minimum (shown in FIG. 12 as zero volts), such as between time zero and t₁, the “non-select row” signal 216 is at its maximum of 0.8 V_{H} volts, the “reflect” column signal 228 is at its maximum of V_{H} volts, the “reflect” column signal 228 is at its maximum of V_{H} volts, and the “scatter” column signal 230 is at its maximum of 0.6 V_{H} volts. Conversely, whenever the “select row” signal 224 is at its voltage maximum (shown in FIG. 12 as V_{H} volts), such as between t₁ and 2ₜ, the “non-select row” signal 226, the “reflect” column signal 228 and the “scatter” column signal 230 are at their respective minimum voltage magnitudes of 0.2 V_{H}, V_{H}, and 0.4 V_{H} volts.

Returning now to FIG. 11, control unit 216 will be described in detail. Control unit 216 is comprised of a display driver 232 and a communications portion 234. Display driver 232 includes a resistor ladder 236 and a decoder logic unit 238. Resistor ladder 236 generates each of the time varying signals 224, 226, 228 and 230, described above. In this respect, resistor ladder 236 generates DC voltage signals by splitting a DC voltage differential applied to a power input contact 240 and a ground contact 242, as is known in the art.

Each row switch 220 and each column switch 222 is connected to decoder logic unit 238 (discussed in detail below) which provides an appropriate signal for selectively connecting each row conductor electrode 204 to either of the “select row” signal or the “non-select row” signal, and selectively connecting each column conductor electrode 210 to either of the “reflect” column signal or the “scatter” column signal. A photosensor 244, in conjunction with an amplifier 246, provides serial input data to logic unit 238 from a modulated illumination source. Decoder logic unit 238 also provides clocking signals to operate switching logic to generate time varying voltage signals 224, 226, 228 and 230.

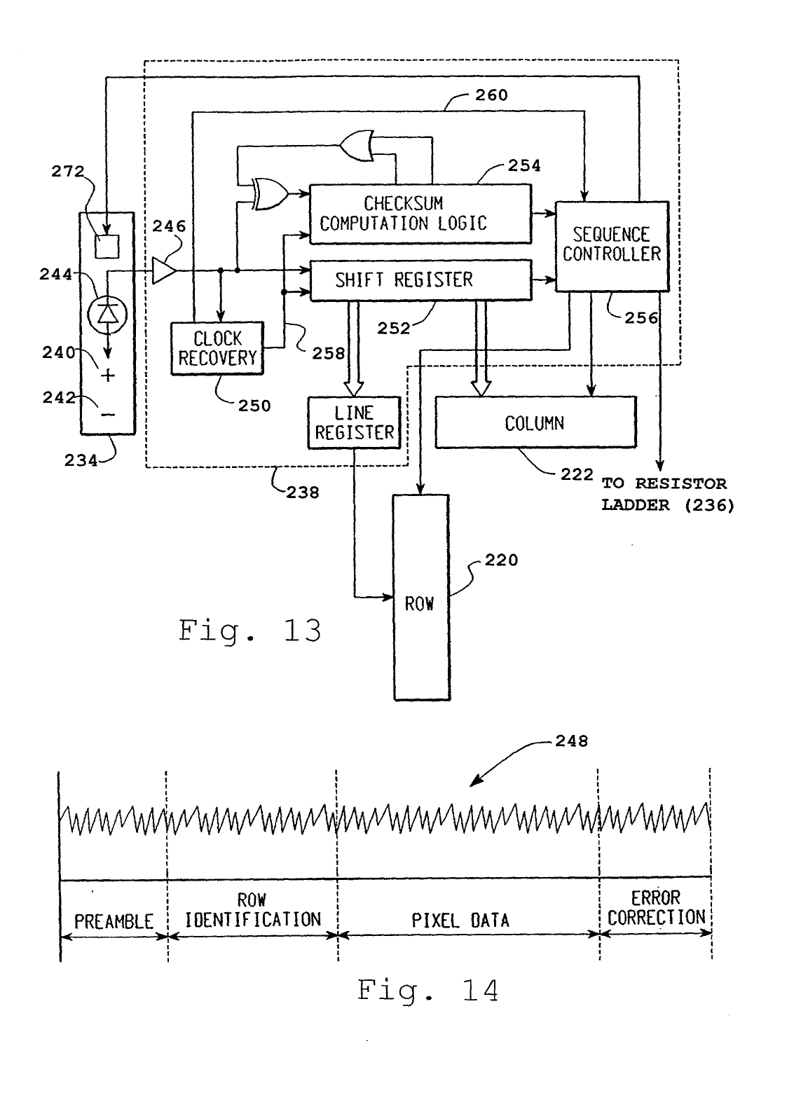

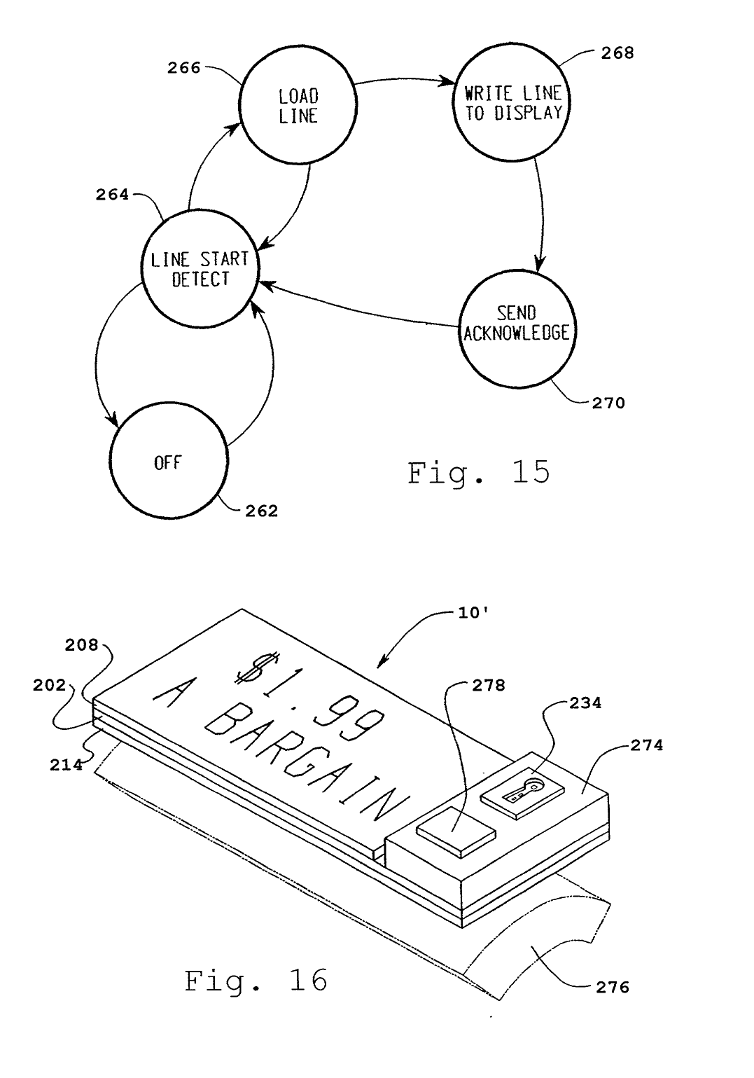

A block diagram of decoder logic unit 238 is shown in FIG. 13. Decoder logic unit 238 converts serial input data 248, (shown diagrammatically in FIG. 14), into row and column switch signals for updating display unit 200. The serial input data includes a preamble portion providing header data, a row identification portion providing row identification data for identifying a row of display unit 200, a pixel data portion for providing sequential pixel data for the row identified in the row identification portion, and an error correction portion for providing checksum data. The sequential pixel data indicates which pixels in the row are to be in a “reflect state” and which are to be in a “scatter state.” It should be appreciated what while the illustrated means in inputting the serial input data to control unit 216 is a modulated light source, other well known input means are also suitable.

Decoder logic unit 238 includes clock recovery logic 250, a shift register 252, checksum computation logic 254, and a sequence controller 256. Clock recovery logic 250 generates a clocking signal 258 in response to incoming serial input data 248. Clocking signal 260 is provided to shift register 252, checksum computation logic 254, and sequence controller 256. Shift register 252 stores the incoming serial input data 248. Checksum computation logic 254 computes a checksum for detecting errors in incoming serial input data 248. Checksum computation logic 254 typically takes the form of a shift register with a feedback loop. Sequence controller 256 compares the checksum data in incoming serial input data 248 with the checksum calculated by the checksum computation logic 254. If the two values match, sequence controller 256 initiates transfer of the data stored in shift register 252 to row switches 220 and column switches 222.

Referring to FIG. 15, there is shown a state diagram of decoder logic unit 238. Decoder logic unit 238 begins in an OFF state 262. When the preamble portion is detected, decoder logic unit 238 transitions to a line start detect state 264 wherein it receives the row identification data, pixel data and checksum data, and stores such data in shift register 252. Provided that the checksum data matches the checksum value calculated by checksum computation logic 254, decoder logic unit 238 transitions to a load line state 266. In load line state 266 the data stored in shift register 252 is applied to row and column switches 220 and 222, respectively, to update a row of pixel elements 218 (i.e., a write line to display state 268). The decoder logic unit 238 then transitions to send acknowledge state 270, causing an LED 272 to momentarily illuminate to indicate a successful update. Next, decoder logic unit 238 transitions back to the line start detect state 264 to receive the next line of serial input data 248.

An embodiment of the physical structure of a shelf tag 10′ incorporating display unit 200 and control unit 216, will now be described with reference to FIG. 16. Shelf tag 10′ includes liquid crystal display (LCD) unit 200 comprised of a layer of liquid crystals 202, sandwiched between front transparent film 208 and light absorbing film 214. The light absorbing film 214 has a length extending beyond the transparent film 208, so that a printed circuit board 274 may be secured to front surface 212 of light absorbing film 214. Printed circuit board 274 is flexible, such that the entire shelf tag 10′ may be bent as shown by dashed lines 276. An integrated circuit chip 278 includes display driver 232 and communications port 234, for connecting a portable programming unit 280 (FIGS. 20 and 21) to circuit chip 278. Portable programing unit 280 (described in detail below) generates a modulated light source which provides the serial input data for programming display unit 200. The foregoing items are secured to printed circuit board 274 using typical ‘chip on flex” technology.

It should be recognized from the foregoing, that shelf tag 10′ provides a very simple structure which can be fabricated using flexible plastic substrates such as Mylar or other suitable flexible plastic materials. These materials are easily produced in the desired configuration and are extremely cost effective, to make shelf tag 10′ viable for large scale use in retain environments. Forming shelf tag 10′ of flexible plastic substrates also makes shelf tag 10′ compatible with common display shelving, wherein shelf tag 10′ can be bent slightly so as to snap into existing retaining devices already attached to such shelving. In this way, shelf tag 10′ does not require any external packaging, again enhancing its cost effective manufacture and use.

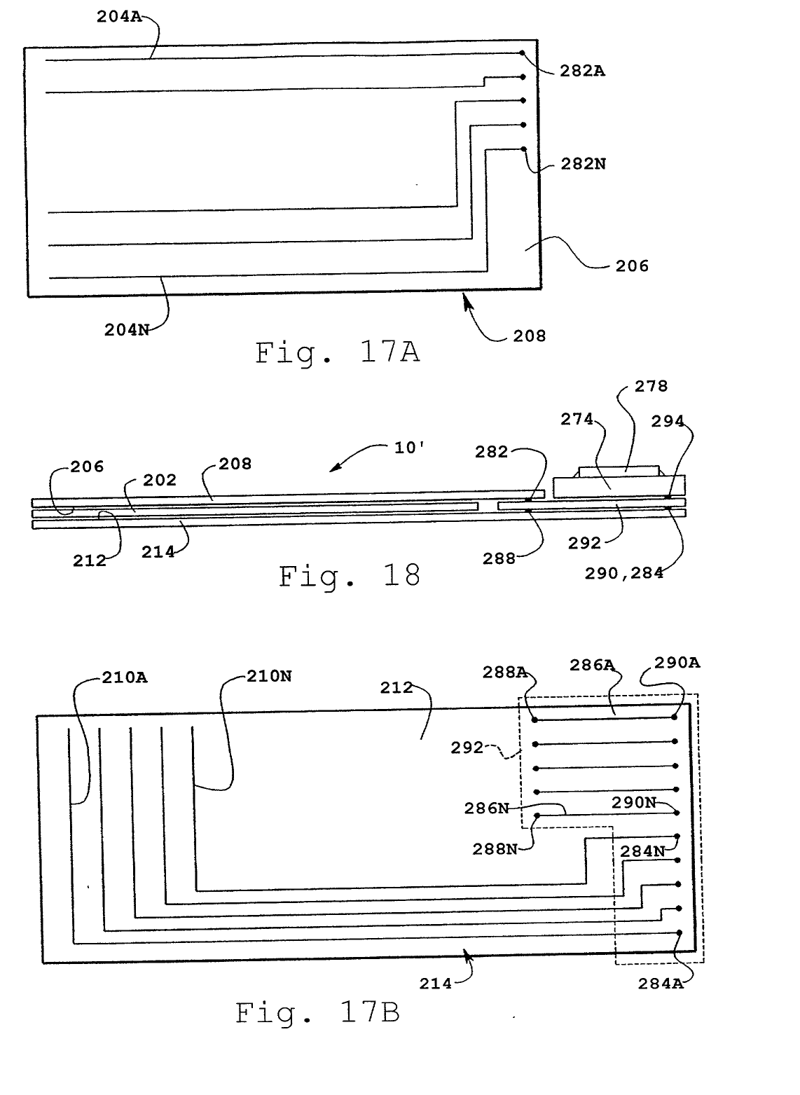

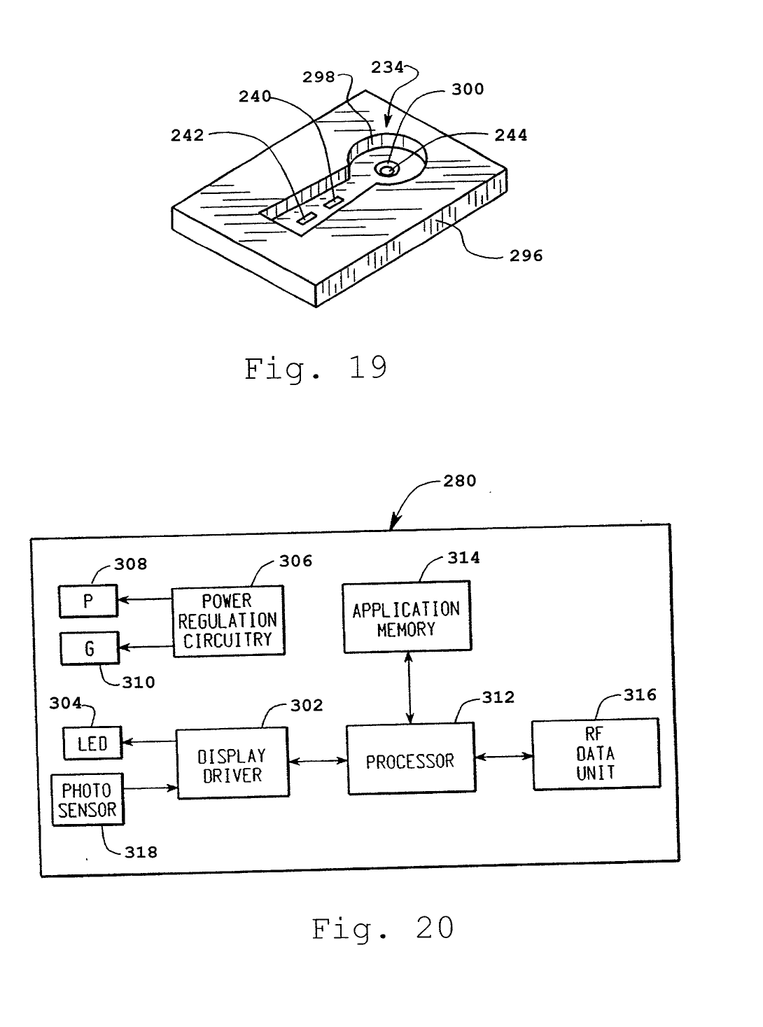

Turning now to FIG. 17A, front transparent film 208 is shown in detail. As indicated above, transparent film 208 is a transparent sheet of a plastic material having front and back surfaces, with back surface 206 having a plurality of transparent row conductor electrodes 204 formed thereon. As an example, a Mylar film or other suitable sheet of plastic material may be coated with a layer of indium tin oxide, which can then be etched to provide row conductor electrodes 204. It will be appreciated that the required number of row conductors electrodes 204 will equal the desired quantity of rows of pixel elements 218. The etching pattern is such that each row conductor electrode 204A-204N will terminate at a row conductor circuit board via contact 282A-282N in the upper right portion of back side 206 of transparent film 208.

Referring now to FIG. 17B, the front surface 212 of light absorbing film 214 is shown in detail. Front surface 212 includes a plurality of transparent column conductor electrodes 210A-210N etched thereon. The etching pattern is such that each column conductor electrode 210A-210N will terminate at a column conductor circuit board via contact 284A-284N in the lower right side of front side 212 of light absorbing film 214. Also etched on front surface 212 are a plurality of row conductor jumpers 286A-286N each of which extends between a jumper via contact 288A-288N and a row conductor circuit board via contact 290A-290N.

Referring now to FIG. 18, there is shown a cross-sectional view of shelf tag 10′. A via layer 292 is sandwiched between printed circuit board 274 and light absorbing film 214, and extends to under the upper right portion of transparent film 208. Via layer 292 has the same thickness as liquid crystals 202 and provides a conductive path from each column conductor circuit board via contact 284A-284N to a corresponding contact 294 on the back side of printed circuit board 274. Via layer 292 also provides a conductive path from each row conductor via contact 282A-282N on the back surface 206 of transparent film 208 to the corresponding jumper via contact 288A-288N on the front surface 212 of light absorbing film 214 and, in turn provides a conductive path between each row conductor circuit board via contact 290A-290N and a corresponding contact 294 on the back side of printed circuit board 274.

In an embodiment of shelf tag 10′, via layer 292 is a z-axis conductive adhesive which also forms a bond between the adjacent components. It should be appreciated that this mechanical alignment of each of the row conductors via contacts 282A-282N to each of the corresponding jumper via contacts 286A-286N, and the alignment of each of the row conductor circuit board contacts 290A-290N and column conductor circuit board contacts 284A-284N to each of the corresponding contacts 294 on the back side of printed circuit board 274, provides for each row conductor and each column conductor to be electrically coupled circuitry on printed circuit board 274.

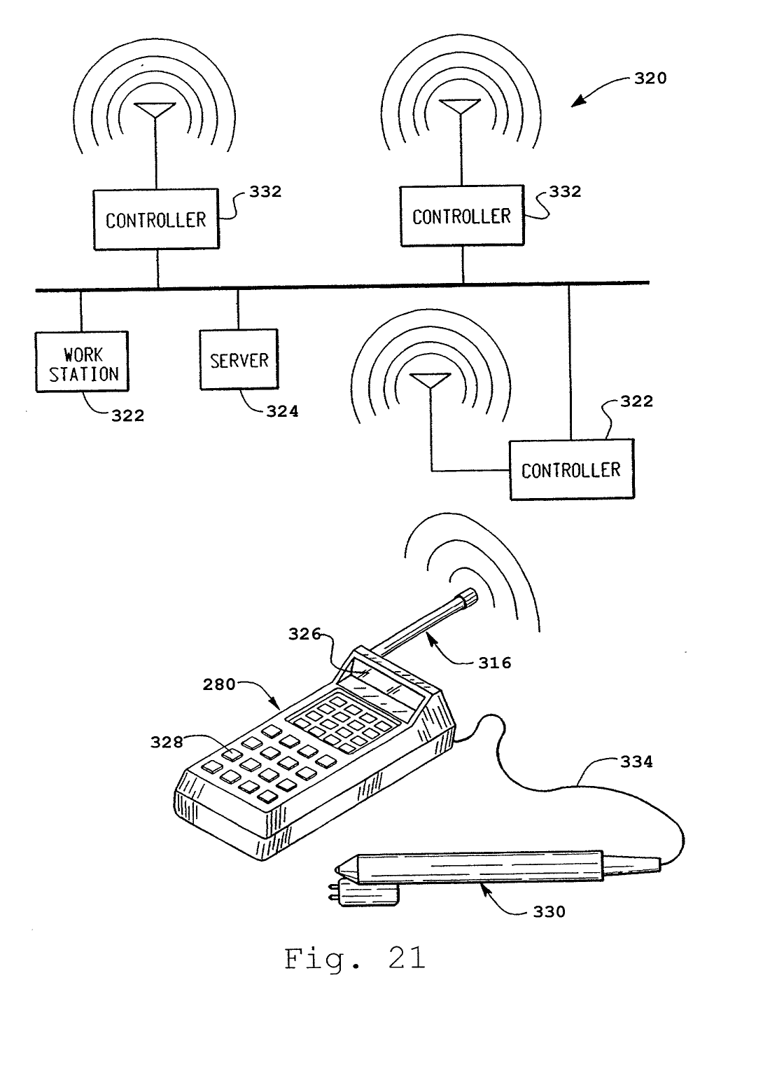

As indicated above, control unit 216 also includes a communications port 234, which will now be described with reference to FIGS. 11 and 19. A physical representation of communications port 234 is shown in FIG. 19. Communications port 234 includes a casing 2956 with a recessed center portion. The recessed center portion has an optical coupling port 298, which includes a photosensor 244 and a lens 300. Lens 300 focuses illumination from a modulated light source onto photosensor 244. Beneath photosensor 244 is a light emitting diode 272, which is directed toward lens 300. Communications port 234 also includes power input contact 240 for a V_{H} power supply, and a ground contact 242. As seen in FIG. 11, power input contact 240 and ground contact 242 are connected to resistor ladder 236 which provides the voltage signals necessary for generating the multiplexed voltage signals for changing the optical state of each pixel element 218. The power input contact 240 and ground contact 242 are also connected to decoder logic unit 238, to provide power thereto,. The signal from the photosensor 244 and the signal to LED 272 are connected to decoder logic unit 238. The serial input data is used to update display unit 200, as described above.

FIG. 20 shows a block diagram of a programming unit 280 in accordance with an embodiment of the present invention. Programming unit 280 is used to program display unit 200 by providing a modulated light source to control unit 216. In this regard, display driver 302 drives LED 304 to provide a modulated light source which is received by photosensor 244 of control unit 216. The modulated light source provides the serial input data for programming display unit 200. Programming unit 280 includes power regulation circuitry 306 which supplies operating power to programming unit 280 and provides a V_{H} voltage differential between a power contact 308 and a ground contact 310. A processor 312 executes application programming stored in an application memory 314 and, optionally in conjunction with data received from an RF data unit 316, generates the desired serial input data. Display driver circuitry 302, which may in part be code executed by processor 312, generates the row update signals and provides signals to modulate LED 304 in response to the serial input data. A photosensor 318 receives acknowledge signals from LED 272 of decoder logic unit 238, and indicates the receipt thereof to display driver 302.

FIG. 21 shows programming unit 280 as used in connection with a computer network 320. Programming unit 280 may access data or information via telemetric signals from a remote workstation 322 or a server 324, using RF data unit 316. Programming unit 280 is further comprised of a liquid crystal display 326, a keypad 328, and a wand 330. A user may enter product information through keypad 328 or by swiping wand 330 across a product bar code. Computer network 320 may take the form of a local area network (LAN) or a wide area network (WAN), and may include a plurality of access points 322 geographically spaced, each of which may communicate data to programming unit 280. Programming unit 280 allows the user to enter product information through keypad 328 or by swiping wand 330 across a product bar code.

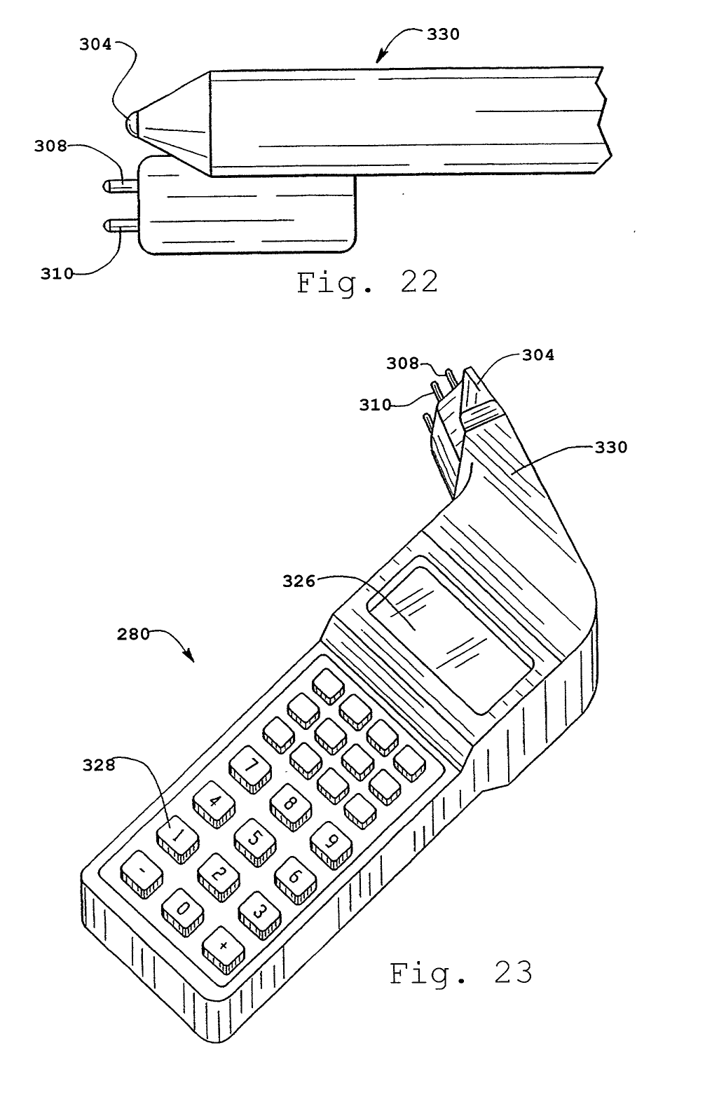

An enlarged view of wand 330 is shown in FIG. 22. Wand 330 includes LED 304, photosensor 318, power contact 308 and ground contact 310, as described in connection with FIG. 20. Photosensor 318 is configured as a typical wand bar code reader. A flexible cable 334 (FIG. 21) is provided to connect wand 330 to programming unit 280.

FIG. 23 depicts an alternative embodiment of programming unit 280. In this embodiment, wand portion 330 is integrated with programming unit 28, rather than being connected by flexible cable 334.

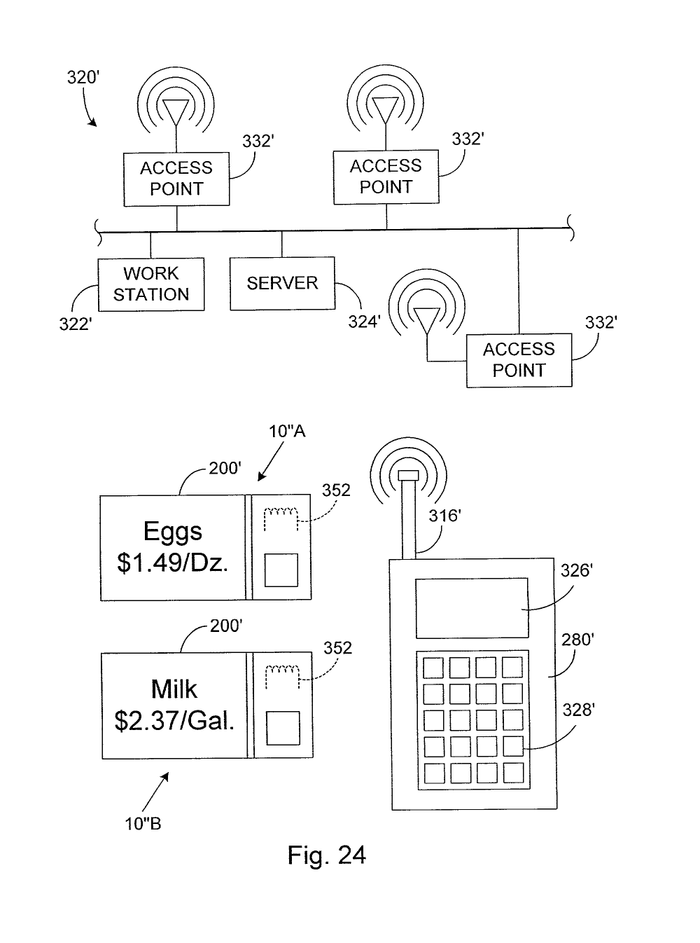

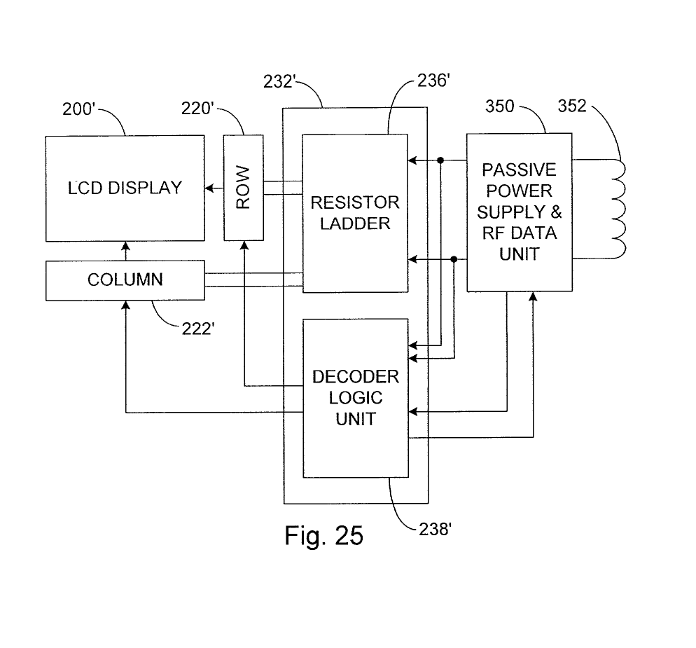

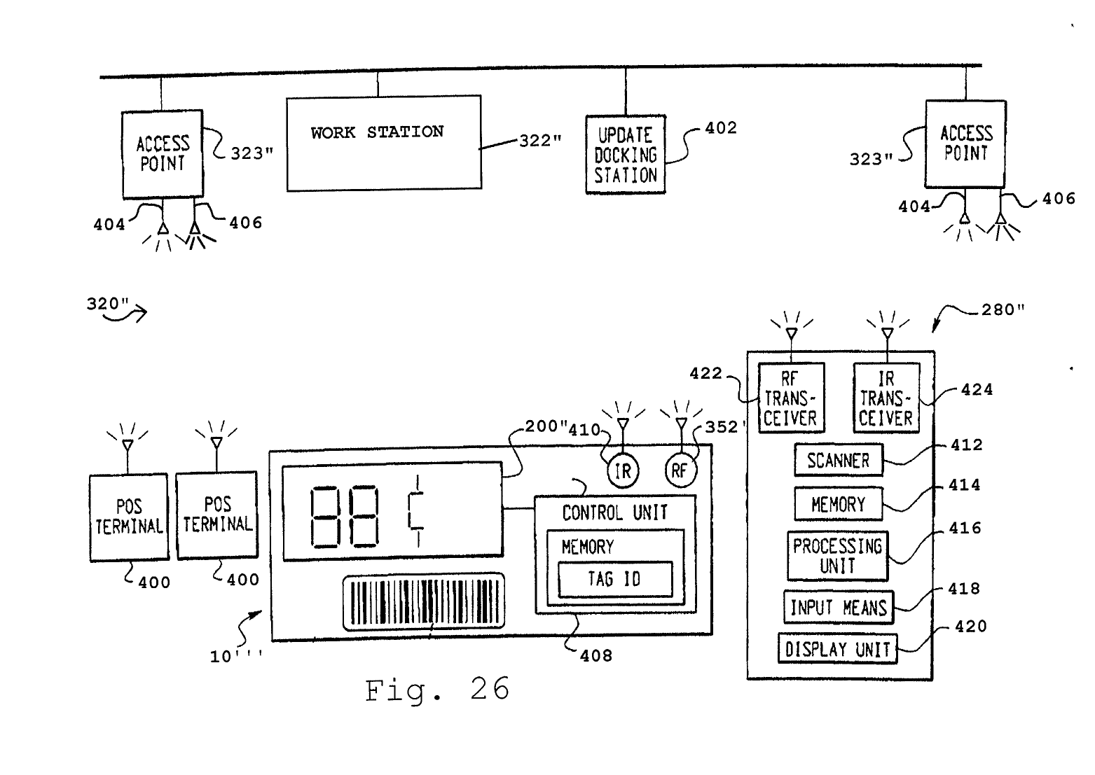

Referring to FIG. 24, a network 320′ is illustrated. The network 320′ is used, in part, to change and update an LCD display 200′ of a third embodiment of the shelf tags 10″. The shelf tags 10″ are very much like the shelf tags of 10′ of the second embodiment. However, no physical connection between the shelf tag 10″ and a programming unit needs to be made to transfer programming data or electrical power to the shelf tag 10″. Rather, each shelf tag 10″ has a passive power supply 350 (FIG. 25) coupled to an inductive coil 352 (FIG. 25). The inductive coil 352 is used to receive both power and data via a radio frequency (RF) signal transmitted by either a programming unit 280′ or an access point 323′ located in strategic proximity to the shelf tag 10″ to be programmed.

With additional reference to FIG. 25, a block diagram of the shelf tag 10″ is illustrated. Similar to the shelf tag 10′, shelf tag 10″ has an LCD display 200′ controlled by a display driver 232′ having a resistor ladder 236′ and a decoder logic unit 238′. The decoder logic unit 238′ activates row switches to 220′ and column switches 222′ to place individual pixel elements of the LCD display 200′ in desired states. These pixels, as in the pixels 218 of the LCD display 200, have two optical states, both of which are stable in the absence of an electric field. For the shelf tag 10″, the communications portion 234 of the shelf tag 10′ has been replaced with the passive power supply and RF data unit 350 and the coil 352. In the presence of an RF signal, the coil 352 will be excited and an electric current through the coil will be induced. Via the power supply portion of the unit 350, the induced current will supply power to the resistor ladder 236′ and the decoder logic unit 238′ for the purposes of decoding programming data supplied to the shelf tag 10″. The induced current is also used for functions including updating the LCD display 200′, transmitting an acknowledgment signal from the shelf tag 10″ to the programming unit 280′ or an access point 333′, and the like. The foregoing operation of the unit 350 and coil 352 is well known in the art and will not be described in great detail. The power supply portion of the unit 350 may include a charge storing device, such as a capacitor, to help deliver power to the various components of the shelf tag 10″.

The RF signal received by the coil 352 of the shelf tag 10″ can include programming data for the shelf tag 10″. The programming data contained in the RF signal is discerned by the unit 350 and supplied to the decoder logic unit 238′ and used to update the display 200′ in the same manner as decoder logic unit 238 updates the shelf tag 10′ of the second embodiment. It is noted that an RF signal broadcast by the programming unit 280′ or by an access point 323′ may be received by more than one shelf tag 10″. Therefore, the RF signal may contain address information corresponding to a unique address associated with each shelf tag 10″. The address of each shelf tag 10″ can be pre-programmed and fixed for each shelf tag 10″ or can be configured as needed. Accordingly, the decoder logic unit 238′ includes a memory device or circuit to retain the address of the shelf tag 10″.

By using a different address for each shelf tag 10″, each tag can be uniquely updated. For example, a first tag 10″A can be updated by transmitting an RF signal from either the programming unit 280′ or an access point 332′. This signal may be received by the coils 352 of the first tag 10″A and a second tag 10″B. Upon receiving the RF signal, both tags 10″A and 10″B would be powered and examine the data component of the RF signal. Tag 10″B would ignore the RF signal since the RF signal contains an address which does not match the address of the tag 10″B. However, tag 10″A would act upon the RD signal, since the RF signal contains an address matching the address of the tag 10″A. The foregoing processing can be implemented in programmed logic executed by the decoder logic unit 238 as will be apparent to one skilled in the art.

In alternative arrangements, the shelf tag 10″ can have a second coil or RF signal receiver, such as an antenna, to receive programming data rather than using the coil 352 to supply both power and programming information to the shelf tag 10″. In an alternative embodiment, the shelf tag 10″ receives power as described above but receives programming data from an optical source such as the LED/photosensor arrangement of the shelf tag 10′. In that case, the optical source transmitting the programming data is part of a hand-held programming unit. Alternatively, the optical source transmitting the programming data to the shelf tag 10″ can be located in a more remote location, such as on an overhead transmitter mounted to the ceiling of the facility where the shelf tag 10″ is deployed (e.g., on an access point 323′).

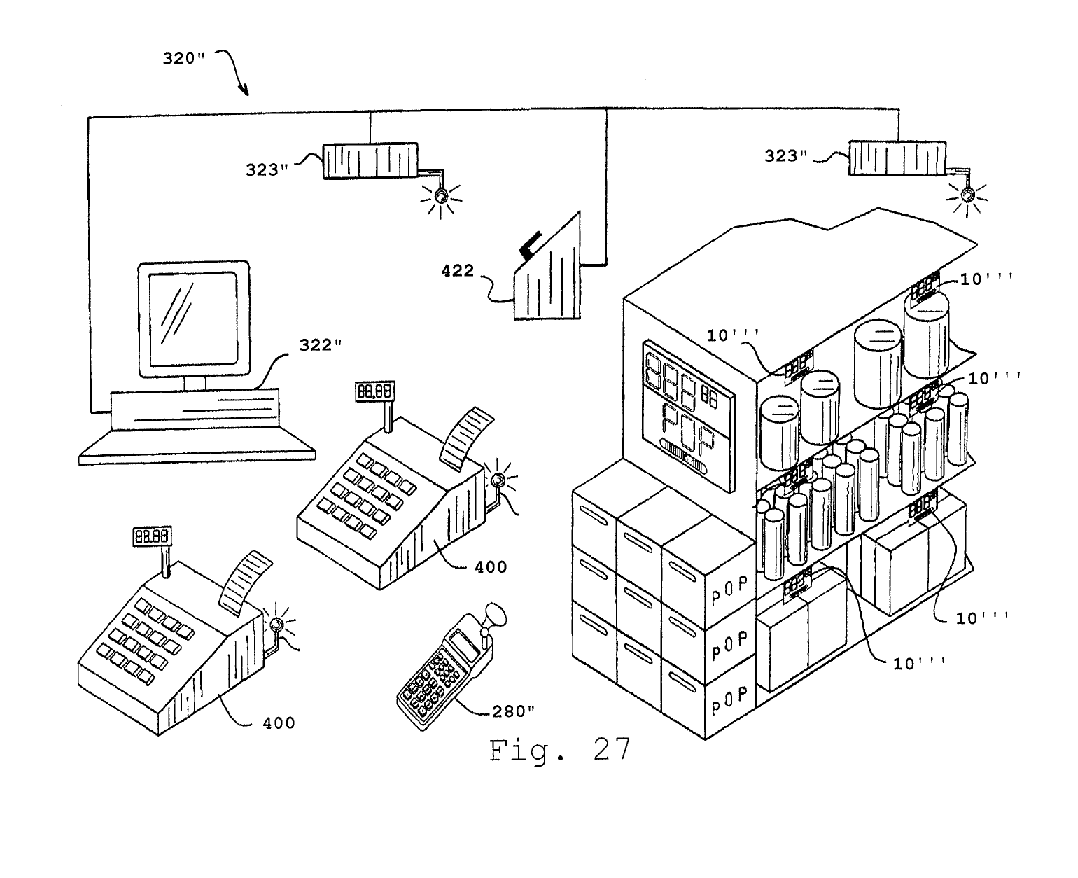

In this regard, FIGS. 26 and 27 illustrate another configuration of a programmable shelf tag system, or network 320″. FIG. 26 provides a detailed block diagram of network 320″, while FIG. 27 illustrates an exemplary physical representation of network 320″ as configured for use in connection with a retail store. Network 320″ is generally comprised of a computer network (e.g., a LAN or WAN), one or more electronic shelf tags 10′″, one or more portable or hand-held programming devices 280″, work station 322″, and access point 323″ at one or more point-of-sale (POS) terminals 400. It will be appreciated that network 320″ is similar to network 320′, electronic shelf 10′″ is similar to shelf tag 10″, programming unit 380′″is similar to programming unit 280′, work station 322″ is similar to work station 322′, and access point 323″ is similar to access point 323′. The network 320″ also includes an update docking station 402 into which the programming unit 380″ can be plugged for recharging, reprogramming, database updating, and/or data transferring between the work station 322″ and the programming unit 380″ via mechanical connection.

Access points 323″ include one or both of an infrared (IR) transceiver and a RF transceiver 406. It will be appreciated that the term transceiver, as used herein, includes a communication device for any of transmitting data only, receiving data only, or transmitting and receiving data. It will be appreciated that while only two access points 323″ are shown, the present invention may include as many access points 323″ as necessary for reliable wireless communications. For instance, each isle in a store may have its own access point 323″.

One or more POS terminals 400 communicate with work station 322″ wirelessly using RF or IR communication means via the access points 323″ or via direct wired or optical link connection. The POS terminals 400 are used in a “check out” procedure, wherein products are scanned and a customer bill is generated. When a product's bar code (e.g., universal product code or UPC) is scanned, the POS terminal 400 interrogates the work station 322″ to obtain the current price of the item from a POS pricing database.

The electronic shelf tag 10′″ is generally comprised of a control unit 408. The control unit 408 includes items described above in more detail, such as a display driver, a decoder logic unit, a memory (e.g., RAM or ROM) for storing a tag identifier or address, row and column switches, etc. The shelf tag 10′″ has a display 200″ having two stable optical states as described above with respect to the other shelf tag embodiments. The shelf tag 10′″ has a RF transceiver 352′ and an IR transceiver 410. The RF transceiver 352′ includes an induction coil as described above to generate power for the shelf tag 10′″ in the presence of a RF signal. Alternatively, the shelf tag 10′″ can be powered by an on board battery or via a wired connection to a power source. The RF transceiver 352′ can also be configured with an antenna. Again, it will be appreciated that the term transceiver, as used herein, includes a communication device for any of transmitting data only, receiving data only, or transmitting and receiving data.

The programming unit 280″ has a scanner 412, a memory 414, a processing unit 416, an input means 418, a display unit 420, a RF transceiver 422, and an infrared transceiver 424. The processing unit 416 provides overall control of the programming unit 280″, and generally takes the form of a microprocessor or microcontroller. The memory 414 stores data, including programming data, and can include RAM and ROM type memories. The memory 414 stores such items as a pricing database, respective tag addresses, and any other information needed to distribute programming data (also referred to herein as display data) to the shelf tags 10′″. The scanner 412 is a scanning device for scanning UPC symbols or other indicia displayed on products associated with the shelf tags 10′″ or indicia located directly on the shelf tag 10′″. For example, the scanner 412 is an optical bar code scanner. The input means 418 allows the user to input information into the programming unit 280″ and can include a keypad, a touch screen, a voice input device, a stylus, connection to the docking station 402, and the like. The input means 418 can be used to enter items of information such as pricing data, product identifiers, and/or shelf tag addresses. The display unit 420 provides a visual display of data to the user, and can be, for example, an LCD display.

Similar to shelf tag 10″, the shelf tag 10′″ derives operating power from an RF signal broadcast by the RF transceiver 422 of the programming unit 280″ or the RF transceiver 406 of the access point 322″. As one skilled in the art will appreciate, power may be derived from a signal outside the radio frequency spectrum and, therefore, any broadcast of an electromagnetic pulse which can be received by a receiver in connection with the shelf tag 10′″ to induce operating power for the shelf tag 10′″ is considered to fall within the scope of the present invention. While the shelf tag 10′″ is being powered by a RF signal, programming data can be transmitted to the shelf tag 10′″ by any of the RF transceiver 422 of the programming unit 280″, the IR transceiver 424 of the programming unit 280″, the RF transmitter 406 of the access point 323″, or the IR transmitter 404 of the access point 323″. Therefore, as can be appreciated, during updating of a plurality of shelf tags, the access point 323″ can broadcast a RF signal of sufficient strength and duration to power the shelf tags 10′″ while an operator carrying a programming unit 280″ walks to a location near each shelf tag 10′″ to be updated and transmits the programming data optically from the programming unit 280″ to the shelf tag 10′″. As one skilled in the art will appreciate, the foregoing is one example of a method for updating the shelf tags and any combination of wireless power inducing signal transmission and information transmission to the shelf tag 10′″ using the transceivers 404, 406, 422 and/or 424 can be used.

The shelf tag 10′″ can be programmed to transmit an acknowledgment signal back to either the programming unit 280″ or the access point 323″ upon receiving programming data and updating the display 200″. This acknowledgment signal can be relayed back to the work station 322″ to track which shelf tags 10′″ have been updated. In addition, the programming unit 280″ and the access point 323″ can communicate wirelessly using either or both of RF transmissions or IR transmissions. In this manner, the work station 322″ can communicate with the programming unit 280″ so that database information, including programming data to be shared with a shelf tag 10′″, can be exchanged.

Although particular embodiments of the invention have been described in detail, it is understood that the invention is not limited correspondingly in scope, but includes all changes, modifications, and equivalent, coming within the spirit and terms of the claims appended hereto.

What is claimed is:

1. An electronic display tag system comprising an electronic display tag including a display for displaying at least one of pricing data and product identification data, the display having bistable character elements or bistable pixels, a decoder logic unit for decoding received programming data and for updating the display based on the programming data, the programming data being received wirelessly, and a wireless transceiver, the wireless transceiver for converting a power inducing signal transmitted wirelessly to the display tag into electrical power, the electrical power used by the decoder logic unit to update the display.

2. The system according to claim 1, wherein the wireless transceiver is an induction coil.

3. The system according to claim 1, wherein the programming data is received via the wireless transceiver.

4. The system according to claim 1, wherein the programming data is received by a second wireless transceiver.

5. The system according to claim 4, wherein the second transceiver is a radio frequency transceiver.

6. The system according to claim 4, wherein the second transceiver is an optical transceiver.

7. The system according to claim 1, further comprising a portable programming unit for wirelessly broadcasting at least one of the programming data and the power inducing signal to the display tag.

8. The system according to claim 1, further comprising an access point for wirelessly broadcasting at least one of the programming data and the power inducing signal to the display tag.

9. The system according to claim 1, wherein the programming data includes an address unique to a particular display tag, the particular display tag selected from a plurality of display tags.

10. The system according to claim 1, where in the programming data and the power inducing signal are transmitted to the display tag together as a radio frequency transmission.

11. A method of programming an electronic display tag, the display tag including a display for displaying at least one of pricing data and product identification data, the display having bistable character elements or bistable pixels, a decoder logic unit for decoding programming data and for updating the display based on the programming data, the method including the steps of:
wirelessly transmitting programming data from a source to the display tag;
wirelessly transmitting a power inducing signal adapted for conversion into electrical power to the display tag;
converting the power inducing signal into electrical power; and
updating the display based on the programming data using the electrical power.

12. The method according to claim 11, wherein the power inducing signal is a radio frequency signal and is converted into electrical power by an induction coil.

13. The method according to claim 11, wherein the programming data and the power inducing signal are received by the display tag via a common wireless transceiver.

14. The method according to claim 11, wherein the power inducing signal is received by the display tag via a first transceiver and the programming data is received by the display tag via a second transceiver.

15. The method according to claim 14, wherein the second transceiver is a radio frequency transceiver.

16. The method according to claim 14, wherein the second transceiver is an optical transceiver.

17. The method according to claim 11, wherein at least one of the programming data and the power inducing signal are broadcast from a portable programming unit.

18. The method according to claim 11, wherein at least one of the programming data and the power inducing signal are broadcast from an access point.

19. The method according to claim 11, wherein the programming data includes an address unique to a particular display tag, the particular display tag selected from a plurality of display tags.

20. The method according to claim 11, wherein the programming data and the power inducing signal are transmitted together as a radio frequency transmission.

21. The method according to claim 11, further comprising the step of wirelessly transmitting the programming data from a workstation to a portable programming unit via an access point, the programming unit transmitting the programming data to the display tag.

22. A programmable electronic display system comprising a display unit having a plurality of pixels in the form of an array matrix, each of the plurality of pixels having a first and second stable optical state in the absence of an electric field, the display unit having a communication port for receiving input data transmitted by a handheld and portable programming unit, said input data including display data indicating an optical state for at least one of said plurality of pixels and the display unit having a decoder for decoding said display data and modifying the optical state of the pixel array in accordance with decoded display data, wherein power is temporarily supplied to the display unit by the programming unit via electrical contacts disposed respectively on the display unit and the programming unit, the power used to decode the display data and modify the optical state of the pixel array.

23. The system according to claim 22, wherein said communication port is adapted to receive optically transmitted data transmitted wirelessly by the programming unit.

24. The system according to claim 22, wherein pixels of the array are arranged as a plurality of rows and columns, and wherein said decoder includes means for selectively enabling rows and columns of pixels to change the optical states thereof.

25. The system according to claim 22, wherein said decoder further comprises error checking means for verifying accuracy of the input data transmitted by the programming unit to the communication port.

26. An electronic shelf tag system comprising:
an electronic shelf tag including a display means for displaying at least one of pricing data and product identification data;
a computer system for storing and communicating programming data; and
a portable programming device for receiving programming data from said computer system, wherein said programming device programs the associated electronic shelf tag in accordance with the programming data received from said computer system, said portable programming device including:
first communications means for wireless communications with said electronic shelf tag,
second communications means for wireless communications with said computer system, and
an electrical connector for temporarily supplying power to the electronic shelf tag during programming of the electronic shelf tag.

27. The system according to claim 26, wherein said first communications means provides bi-directional communications with said electronic shelf tag.

28. A method for setting an optical display device having a matrix of pixels arranged in rows and columns wherein the plurality of pixels are stable in two optical states, the method comprising:
selectively establishing a physical electrical connection between a display device and a portable programming unit to communicate power to the display device from the programming unit and contemporaneously communicating display data to the display device from the programming unit, the display data providing a pattern for the matrix of pixels; and
updating the matrix of pixels based on the display data.

29. The method according to claim 28, further comprising the step of transmitting the display data to the programming unit from an associated digital network.

30. A method for programming an electronic display having a plurality of pixels arranged in rows and columns to form a pixel array matrix wherein the plurality of pixels are stable in two optical states, the method comprising:
wirelessly transmitting display data from a programming unit to a communication port, the display data indicating an optical state for each of the plurality of pixels;
decoding the display data received by the communication port to obtain decoded display data;
modifying the optical state of the pixel array in accordance with the decoded display data; and
establishing a temporary electrical connection between the programming unit and the electronic display to provide power from the programming unit to the electronic display for decoding the display data and modifying the optical state of the pixel array.

31. The method according to claim 30, wherein said method further comprises the step of transmitting the display data to the programming unit from a remote source.
